(19) United States
(12) Patent Application Publication
(10) Pub. No.: US 2018/0351414 A1
(43) Pub. Date: Dec. 6, 2018

(54) WIRELESS POWER TRANSMITTER SUPPORTING MULTIPLE MODES

(71) Applicant: LG INNOTEK CO., LTD., Seoul (KR)

(72) Inventor: Yu Ri PARK, Seoul (KR)

(73) Assignee: LG INNOTEK CO., LTD., Seoul (KR)

(21) Appl. No.: 15/776,917

(22) PCT Filed: Dec. 12, 2016
(86) PCT No.: PCT/KR2016/014528

§ 371 Date: May 17, 2018

(30) Foreign Application Priority Data
Dec. 24, 2015 (KR) 10-2015-0186102

(51) Int. Cl. H02J 50/40; H02J 50/12; H02J 7/02; H01F 38/14; H01F 27/36; H02J 50/70

(52) U.S. Cl. CPC H02J 50/40; H02J 50/12; H02J 50/70; H01F 38/14; H01F 27/365; H02J 7/025

(57) ABSTRACT

The present invention relates to a wireless power transmission technology and, more particularly, to a wireless power transmitter capable of increasing the probability that wireless power transmission will succeed, thereby improving performance. A wireless power transmitter according to an embodiment of the present invention comprises: a first coil printed circuit board (PCB) comprising an induction coil for transmitting a power signal in a first frequency band to a wireless power receiver coil having a first coupling coefficient; a second coil PCB formed on the upper or lower portion of the first coil PCB, the second coil PCB comprising a resonance coil for transmitting a power signal in a second frequency band to a wireless power receiver coil having a second coupling coefficient; and a control circuit PCB formed beneath the first and second coil PCBs so as to control the induction coil and the resonance coil, wherein the induction coil has a charging area on the upper portion of the first coil PCB, the resonance coil has a charging area on the upper portion of the second coil PCB, and the charging area of the induction coil may at least partially overlap with the charging area of the resonance coil.

### TECHNICAL FIELD

Embodiments relate to wireless power transmission technology, and more particularly, to a wireless power transmitter capable of improving performance by enhancing the probability of wireless power transmission.

### BACKGROUND ART

Recently, as information and communication technology rapidly develops, a ubiquitous society based on information and communication technology is being formed.

To allow information communication devices to be connected anytime and anywhere, sensors equipped with a computer chip having a communication function should be installed in all facilities. Therefore, supply of power to these devices or sensors is a new challenge. In addition, as the kinds of portable devices such as Bluetooth handsets and music players like iPods, as well as mobile phones, rapidly increase in number, charging batteries thereof has required time and effort. As a way to address this issue, wireless power transmission technology has recently drawn attention.

Wireless power transmission (or wireless energy transfer) is a technology for wirelessly transmitting electric energy from a transmitter to a receiver based on the induction principle of a magnetic field. In the 1800s, electric motors or transformers based on electromagnetic induction began to be used. Thereafter, a method of transmitting electric energy by radiating a high frequency wave or an electromagnetic wave, such as a radio wave or laser, was tried. Electric toothbrushes and some common wireless shavers are charged through electromagnetic induction.

Wireless energy transmission techniques introduced up to now may be broadly divided into magnetic induction, electromagnetic resonance, and RF transmission employing a short wavelength radio frequency.

In the magnetic induction scheme, when two coils are arranged adjacent each other and current is applied to one of the coils, a magnetic flux generated at this time generates electromotive force in the other coil. This technology is being rapidly commercialized mainly for small devices such as mobile phones. In the electromagnetic induction scheme, power of up to several hundred kilowatts (kW) may be transmitted with high efficiency, but the maximum transmission distance is less than or equal to 1 cm. As a result, devices are generally required to be placed adjacent to a charger or a pad, which is disadvantageous. The magnetic induction scheme refers to power transmission between tightly coupled transmission and reception coils. When transmission and reception coils having the same shape are aligned, power transmission is performed with high efficiency. For this reason, a band from 100 kHz to 220 kHz may be used in place of a high frequency.

The magnetic resonance scheme uses an electric field or a magnetic field instead of employing an electromagnetic wave or current. The magnetic resonance scheme is advantageous in that the scheme is safe for other electronic devices or the human body since it is hardly influenced by electromagnetic waves. However, the distance and space available for this scheme are limited, and the energy transfer efficiency of the scheme is somewhat low. The magnetic resonance scheme refers to a scheme of power transmission between loosely coupled transmission/reception coils. The transmission/reception coils may have different shapes and the transmission coil is generally larger than the reception coil. In this scheme, power for power transmission is increased using a driver such as a power amplifier and/or a DC-DC converter, and power is transmitted using a high frequency band (for example, 6.78 MHz).

The short-wavelength wireless power transmission scheme (simply, RF transmission scheme) takes advantage of the fact that energy can be transmitted and received directly in the form of radio waves. This technique is an RF-based wireless power transmission scheme using a rectenna. A rectenna, which is a compound word of antenna and rectifier, refers to a device that converts RF power directly into direct current (DC) power. That is, the RF scheme is a technique of converting AC radio waves into DC waves. Recently, with improvement in efficiency, commercialization of RF technology has been actively researched.

The wireless power transmission technology is employable in various industries including IT, railroads, and home appliances as well as the mobile industry.

Recently, wireless power transmitters equipped with a plurality of coils have been introduced to increase the recognition rate of a wireless power receiver placed on a charging bed. In addition, a wireless power transmitter supporting multiple modes may include coils that support various schemes such as the magnetic resonance scheme and the magnetic induction scheme. Placing such coils in the same plane may produce a region where wireless power transmission to the wireless power receiver cannot be performed.

### DISCLOSURE

### Technical Problem

Therefore, the present disclosure has been made in view of the above problems, and embodiments provide a wireless power transmitter supporting multiple modes.

Embodiments also provide a wireless power transmitter capable of enhancing the efficiency of wireless power transmission by preventing a non-rechargeable region from being produced.

The technical objects that can be achieved through the embodiments are not limited to what has been particularly described hereinabove and other technical objects not described herein will be more clearly understood by persons skilled in the art from the following detailed description.

### Technical Solution

In one embodiment, a wireless power transmitter supporting multiple modes may include a first coil PCB (printed circuit board) comprising an induction coil for transmitting a power signal of a first frequency band to a wireless power receiver coil having a first coupling coefficient, a second coil PCB formed over or under the first coil PCB, the second coil PCB comprising a resonant coil for transmitting a power signal of a second frequency band to a wireless power receiver coil having a second coupling coefficient, and a control circuit PCB formed under the first coil PCB and the second coil PCB and configured to control the induction coil and the resonant coil, wherein a charging area of the induction coil may be over the first coil PCB, and a charging area of the resonant coil may be over the second coil PCB, wherein the charging area of the induction coil at least partially may overlap the charging area of the resonant coil.

The wireless power transmitter may further include a first connector configured to electrically connect the first coil PCB and the control circuit PCB.

The second coil PCB may include a connector hole allowing the first connector to pass therethrough.

The wireless power transmitter may further include a second connector configured to electrically connect the second coil PCB and the control circuit PCB.

The induction coil may include three transmission induction coils positioned to at least partially overlap each other.

The wireless power transmitter may further include ferrite for shielding a magnetic field, the ferrite being positioned between the second coil PCB and the control circuit PCB.

The first coupling coefficient may be greater than the second coupling coefficient, wherein a range of the first frequency band may be below a range of the second frequency band.

A range of the first coupling coefficient may be from 0 to 0.2 and a range of the first frequency band may be from 90 kHz to 300 kHz or from 100 kHz to 220 kHz.

A range of the second coupling coefficient may be from 0.5 to 1.0 and a range of the second frequency band may be from 6 MHz to 8 MHz.

In another embodiment, a wireless power transmitter supporting multiple modes may include a first coil PCB (printed circuit board) comprising an induction coil for transmitting a power signal of a first frequency band to a wireless power receiver coil having a first coupling coefficient, a second coil PCB formed over or under the first coil PCB, the second coil PCB comprising a resonant coil for transmitting a power signal of a second frequency band to a wireless power receiver coil having a second coupling coefficient, a control circuit PCB formed under the first coil PCB and the second coil PCB and configured to control the induction coil and the resonant coil, and a first connector configured to electrically connect the first coil PCB and the control circuit PCB, wherein a charging area of the induction coil may over the first coil PCB, and a charging area of the resonant coil may be over the second coil PCB, wherein the charging area of the induction coil at least partially may overlap the charging area of the resonant coil.

The above-described aspects of the present disclosure are merely a part of preferred embodiments of the present disclosure. Those skilled in the art will derive and understand various embodiments reflecting the technical features of the present disclosure from the following detailed description of the present disclosure.

### Advantageous Effects

The apparatus according to the embodiments has the following effects.

In a wireless power transmitter according to an embodiment of the present disclosure, a first coil PCB including an induction coil and a second coil PCB including a resonant coil are not implemented in the same plane but are arranged to vertically overlap. Thereby, a dead zone, which is a non-rechargeable region, may not be produced.

In addition, the first coil PCB may be formed at an upper position close to the wireless power receiver such that the induction coil, whose wireless power transmission efficiency is greatly affected by the distance to the wireless power receiver, can be positioned closer to the wireless power receiver. Thereby, the efficiency of wireless power transmission may be optimized.

It will be appreciated by those skilled in the art that that the effects that can be achieved through the embodiments of the present disclosure are not limited to those described above and other advantages of the present disclosure will be more clearly understood from the following detailed description.

### DESCRIPTION OF DRAWINGS

The accompanying drawings, which are included to provide a further understanding of the disclosure and are incorporated in and constitute a part of this application, illustrate embodiments of the disclosure and together with the description serve to explain the principle of the disclosure.

FIG. 1 is a system configuration diagram illustrating a wireless power transmission method using an electromagnetic resonance scheme according to an embodiment of the present disclosure.

FIG. 2 is a diagram illustrating a type and characteristics of a wireless power transmitter in an electromagnetic resonance scheme according to an embodiment of the present disclosure.

FIG. 3 is a diagram illustrating a type and characteristics of a wireless power receiver in an electromagnetic resonance scheme according to an embodiment of the present disclosure.

FIG. 4 shows an equivalent circuit diagram of a wireless power transmission system supporting an electromagnetic resonance scheme according to an embodiment of the present disclosure.

FIG. 5 is a state transition diagram illustrating a state transition procedure in a wireless power transmitter supporting an electromagnetic resonance scheme according to an embodiment of the present disclosure.

FIG. 6 is a state transition diagram illustrating a state transition procedure of a wireless power receiver in an electromagnetic resonance scheme according to an embodiment of the present disclosure.

FIG. 7 illustrates operation regions of a wireless power receiver according to V_{RECT} in an electromagnetic resonance scheme according to an embodiment of the present disclosure.

FIG. 8 is a diagram illustrating a wireless charging system in an electromagnetic induction scheme according to an embodiment of the present disclosure.

FIG. 9 is a state transition diagram of a wireless power transmitter supporting an electromagnetic induction scheme according to an embodiment of the present disclosure.

FIG. 10 is a block diagram illustrating a structure of a wireless power transmitter supporting multiple modes according to an embodiment of the present disclosure.

FIG. 11 is a view illustrating a wireless power transmitter supporting multiple modes according to a comparative example of the present disclosure.

FIG. 12 is a cross-sectional view illustrating a structure of a wireless power transmitter supporting multiple modes according to an embodiment of the present disclosure.

FIG. 13 is a simplified plan view of a first coil PCB shown in FIG. 12.

FIG. 14 is a schematic plan view of a second coil PCB shown in FIG. 12.

FIG. 15 is a view showing one side of coupling of the substrates of an embodiment shown in FIG. 12.

FIG. 16 is a view showing the other side of the coupling of the substrates of the embodiment shown in FIG. 12.

### BEST MODE

A wireless power transmitter supporting multiple modes according to a first embodiment of the present disclosure includes a first coil PCB (printed circuit board) including an induction coil for transmitting a power signal of a first frequency band to a wireless power receiver coil having a first coupling coefficient; a second coil PCB formed over or under the first coil PCB, the second coil PCB including a resonant coil for transmitting a power signal of a second frequency band to a wireless power receiver coil having a second coupling coefficient; and a control circuit PCB formed under the first coil PCB and the second coil PCB and configured to control the induction coil and the resonant coil, wherein a charging area of the induction coil is over the first coil PCB, and a charging area of the resonant coil is over the second coil PCB, wherein the charging area of the induction coil may at least partially overlap the charging area of the resonant coil.

### MODE FOR INVENTION

Hereinafter, an apparatus and various methods to which embodiments of the present disclosure are applied will be described in detail with reference to the drawings. As used herein, the suffixes “module” and “unit” are added or used interchangeably to facilitate preparation of this specification and are not intended to suggest distinct meanings or functions.

While all elements constituting embodiments of the present disclosure have been described as being connected into one body or operating in connection with each other, the disclosure is not limited to the described embodiments. That is, within the scope of the present disclosure, one or more of the elements may be selectively connected to operate. In addition, although all elements can be implemented as one independent hardware device, some or all of the elements may be selectively combined to implement a computer program having a program module for executing a part or all of the functions combined in one or more hardware devices. Code and code segments that constitute the computer program can be easily inferred by those skilled in the art. The computer program may be stored in a computer-readable storage medium, read and executed by a computer to implement an embodiment of the present disclosure. The storage medium of the computer program may include a magnetic recording medium, an optical recording medium, and a carrier wave medium.

In the description of the embodiments, it is to be understood that when an element is described as being “on” or “under” and “before” or “after” another element, it can be “directly” “on” or “under” and “before” or “after” another element or can be “indirectly” formed such that one or more other intervening elements are also present between the two elements.

The terms “include,” “comprise” and “have” should be understood as not precluding the possibility of existence or addition of one or more other components unless otherwise stated. All terms, including technical and scientific terms, have the same meaning as commonly understood by one of ordinary skill in the art to which this disclosure pertains, unless otherwise defined. Commonly used terms, such as those defined in typical dictionaries, should be interpreted as being consistent with the contextual meaning of the relevant art, and are not to be construed in an ideal or overly formal sense unless expressly defined to the contrary.

In describing the components of the present disclosure, terms such as first, second, A, B, (a), and (b) may be used. These terms are used only for the purpose of distinguishing one constituent from another, and the terms do not limit the nature, order or sequence of the components. When one component is said to be “connected,” “coupled” or “linked” to another, it should be understood that this means the one component may be directly connected or linked to another one or another component may be interposed between the components.

In the description of the embodiments, “wireless power transmitter,” “wireless power transmission device,” “transmission terminal,” “transmitter,” “transmission device,” “transmission side,” and the like will be interchangeably used to refer to a device for transmitting wireless power in a wireless power system, for simplicity.

In addition, “wireless power reception device,” “wireless power receiver,” “reception terminal,” “reception side,” “reception device,” “receiver,” and the like will be interchangeably used to refer to a device for receiving wireless power from a wireless power transmission device, for simplicity.

The wireless power transmitter according to the present disclosure may be configured as a pad type, a cradle type, an access point (AP) type, a small base station type, a stand type, a ceiling embedded type, a wall-mounted type, a vehicle embedded type, a vehicle resting type, or the like. One transmitter may transmit power to a plurality of wireless power reception devices at the same time.

To this end, the wireless power transmitter may provide at least one wireless power transmission scheme, including, for example, an electromagnetic induction scheme, an electromagnetic resonance scheme, and the like.

For example, for the wireless power transmission schemes, various wireless power transmission standards based on an electromagnetic induction scheme for charging using an electromagnetic induction principle in which a magnetic field is generated in a power transmission terminal coil and electricity is induced in a reception terminal coil by the influence of the magnetic field may be used. Here, the electromagnetic induction type wireless power transmission standards may include an electromagnetic induction type wireless charging technique defined in a Wireless Power Consortium (WPC) technique or a Power Matters Alliance (PMA) technique.

In another example, a wireless power transmission scheme may employ an electromagnetic resonance scheme in which a magnetic field generated by a transmission coil of a wireless power transmitter is tuned to a specific resonant frequency and power is transmitted to a wireless power receiver located at a short distance therefrom. For example, the electromagnetic resonance scheme may include a resonance type wireless charging technique defined in Alliance for Wireless Power (A4WP), which is a wireless charging technology standard organization.

In another example, a wireless power transmission scheme may employ an RF wireless power transmission scheme in which low power energy is transmitted to a wireless power receiver located at a remote location over an RF signal.

In another example of the present disclosure, the wireless power transmitter according to the present disclosure may be designed to support at least two wireless power transmission schemes among the electromagnetic induction scheme, the electromagnetic resonance scheme, and the RF wireless power transmission scheme.

In this case, the wireless power transmitter may determine not only a wireless power transmission scheme that the wireless power transmitter and the wireless power receiver are capable of supporting, but also a wireless power transmission scheme which may be adaptively used for the wireless power receiver based on the type, state, required power, etc. of the wireless power receiver.

A wireless power receiver according to an embodiment of the present disclosure may be provided with at least one wireless power transmission scheme, and may simultaneously receive wireless power from two or more wireless power transmitters. Here, the wireless power transmission scheme may include at least one of the electromagnetic induction scheme, the electromagnetic resonance scheme, and the RF wireless power transmission scheme.

The wireless power receiver according to the present disclosure may be embedded in small electronic devices such as a mobile phone, a smartphone, a laptop computer, a digital broadcast terminal, a PDA (Personal Digital Assistant), a PMP (Portable Multimedia Player), a navigation system, an MP3 player, an electric toothbrush, an electronic tag, a lighting device, a remote control, a fishing float, and the like. However, embodiments are not limited thereto, and the wireless power receiver may be applied to any devices which may be provided with the wireless power receiving means according to the present disclosure and be charged through a battery. A wireless power receiver according to another embodiment of the present disclosure may be mounted on a vehicle, an unmanned aerial vehicle, a drone, and the like.

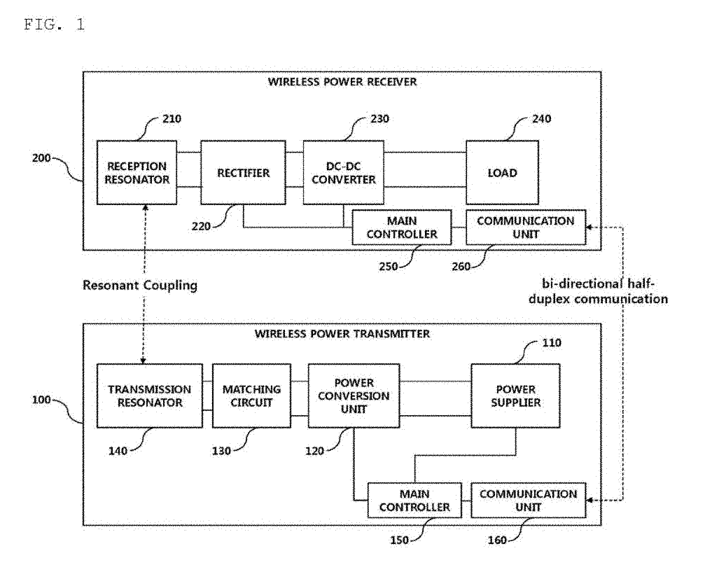

FIG. 1 is a system configuration diagram illustrating a wireless power transmission method using an electromagnetic resonance scheme according to an embodiment of the present disclosure.

Referring to FIG. 1, a wireless power transmission system may include a wireless power transmitter 100 and a wireless power receiver 200.

While FIG. 1 illustrates that the wireless power transmitter 100 transmits wireless power to one wireless power receiver 200, this is merely one embodiment, and the wireless power transmitter 100 according to another embodiment of the present disclosure may transmit wireless power to a plurality of wireless power receivers 200. It should be noted that the wireless power receiver 200 according to yet another embodiment may simultaneously receive wireless power from a plurality of wireless power transmitters 100.

The wireless power transmitter 100 may generate a magnetic field using a specific power transmission frequency (for example, a resonant frequency) to transmit power to the wireless power receiver 200.

The wireless power receiver 200 may receive power by tuning to the same frequency as the power transmission frequency used by the wireless power transmitter 100.

As an example, the frequency used for power transmission may be, but is not limited to, a 6.78 MHz band.

That is, the power transmitted by the wireless power transmitter 100 may be communicated to the wireless power receiver 200 that is in resonance with the wireless power transmitter 100.

The maximum number of wireless power receivers 200 capable of receiving power from one wireless power transmitter 100 may be determined based on the maximum transmit power level of the wireless power transmitter 100, the maximum power reception level of the wireless power receiver 200, and the physical structures of the wireless power transmitter 100 and the wireless power receiver 200.

The wireless power transmitter 100 and the wireless power receiver 200 can perform bidirectional communication in a frequency band different from the frequency band for wireless power transmission, i.e., the resonant frequency band. As an example, bidirectional communication may employ, without being limited to, a half-duplex Bluetooth low energy (BLE) communication protocol.

The wireless power transmitter 100 and the wireless power receiver 200 may exchange the characteristics and state information on each other including, for example, power negotiation information for power control via bidirectional communication.

As an example, the wireless power receiver 200 may transmit predetermined power reception state information for controlling the level of power received from the wireless power transmitter 100 to the wireless power transmitter 100 via bidirectional communication. The wireless power transmitter 100 may dynamically control the transmit power level based on the received power reception state information. Thereby, the wireless power transmitter 100 may not only optimize the power transmission efficiency, but also provide a function of preventing load breakage due to overvoltage, a function of preventing power from being wasted due to under-voltage, and the like.

The wireless power transmitter 100 may also perform functions such as authenticating and identifying the wireless power receiver 200 through bidirectional communication, identifying incompatible devices or non-rechargeable objects, identifying a valid load, and the like.

Hereinafter, a wireless power transmission process according to the resonance scheme will be described in more detail with reference to FIG. 1.

The wireless power transmitter 100 may include a power supplier 110, a power conversion unit 120, a matching circuit 130, a transmission resonator 140, a main controller 150, and a communication unit 160. The communication unit may include a data transmitter and a data receiver.

The power supplier 110 may supply a specific supply voltage to the power conversion unit 120 under control of the main controller 150. The supply voltage may be a DC voltage or an AC voltage.

The power conversion unit 120 may convert the voltage received from the power supplier 110 into a specific voltage under control of the main controller 150. To this end, the power conversion unit 120 may include at least one of a DC/DC converter, an AC/DC converter, and a power amplifier.

The matching circuit 130 is a circuit that matches impedances between the power conversion unit 120 and the transmission resonator 140 to maximize power transmission efficiency.

The transmission resonator 140 may wirelessly transmit power using a specific resonant frequency according to the voltage applied from the matching circuit 130.

The wireless power receiver 200 may include a reception resonator 210, a rectifier 220, a DC-DC converter 230, a load 240, a main controller 250 and a communication unit 260. The communication unit may include a data transmitter and a data receiver.

The reception resonator 210 may receive power transmitted by the transmission resonator 140 through the resonance effect.

The rectifier 220 may function to convert the AC voltage applied from the reception resonator 210 into a DC voltage.

The DC-DC converter 230 may convert the rectified DC voltage into a specific DC voltage required by the load 240.

The main controller 250 may control the operation of the rectifier 220 and the DC-DC converter 230 or may generate the characteristics and state information on the wireless power receiver 200 and control the communication unit 260 to transmit the characteristics and state information on the wireless power receiver 200 to the wireless power transmitter 100. For example, the main controller 250 may monitor the intensities of the output voltage and current from the rectifier 220 and the DC-DC converter 230 to control the operation of the rectifier 220 and the DC-DC converter 230.

The intensity information on the monitored output voltage and current may be transmitted to the wireless power transmitter 100 through the communication unit 260.

In addition, the main controller 250 may compare the rectified DC voltage with a predetermined reference voltage and determine whether the voltage is in an overvoltage state or an under-voltage state. When a system error state is sensed as a result of the determination, the controller 250 may transmit the sensed result to the wireless power transmitter 100 through the communication unit 260.

When the system error state is sensed, the main controller 250 may control the operation of the rectifier 220 and the DC-DC converter 230 or control the power applied to the load 240 using a predetermined overcurrent interruption circuit including a switch and/or a Zener diode, in order to prevent the load from being damaged.

In FIG. 1, the main controller 150 or 250 and the communication unit 160 or 260 of each of the transmitter and the receiver are shown as being configured as different modules, but this is merely one embodiment. It is to be noted that the main controller 150 or 250 and the communication unit 160 or 260 may be configured as a single module.

When an event such as addition of a new wireless power receiver to a charging area during charging, disconnection of a wireless power receiver that is being charged, completion of charging of the wireless power receiver, or the like is sensed, the wireless power transmitter 100 according to an embodiment of the present disclosure may perform a power redistribution procedure for the remaining wireless power receivers to be charged. The result of power redistribution may be transmitted to the connected wireless power receiver(s) via out-of-band communication.

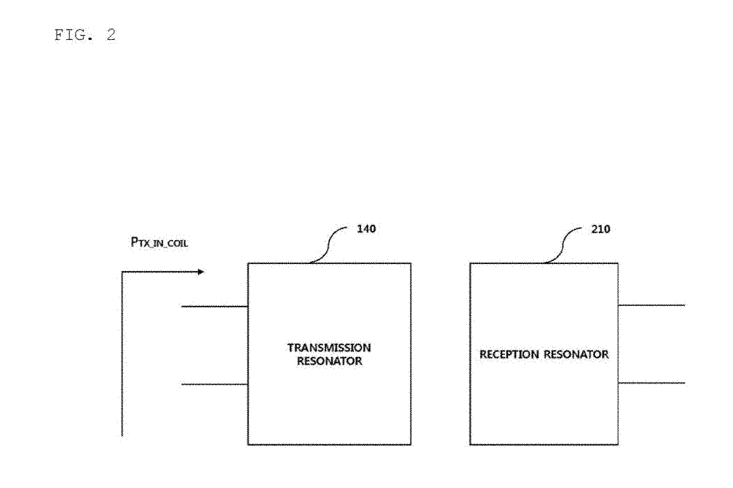

FIG. 2 is a diagram illustrating a type and characteristics of a wireless power transmitter in an electromagnetic resonance scheme according to an embodiment of the present disclosure.

Types and characteristics of the wireless power transmitter and the wireless power receiver according to the present disclosure may be classified into classes and categories.

The type and characteristics of the wireless power transmitter may be broadly identified by the following three parameters.

First, the wireless power transmitter may be identified by a class determined according to the intensity of the maximum power applied to the transmission resonator 140.

Here, the class of the wireless power transmitter may be determined by comparing the maximum value of the power P_{TX}_{_}_{IN}_{_}_{COIL} applied to the transmission resonator 140 with a predefined maximum input power for each class specified in a wireless power transmitter class table (hereinafter referred to as Table 1). Here, P_{TX}_{_}_{IN}_{_}_{COIL} may be an average real number value calculated by dividing the product of the voltage V(t) and the current I(t) applied to the transmission resonator 140 for a unit time by the unit time.

TABLE 1

| | Maximum | | Minimum category | Maximum number |
|---|---|---|---|---|
| | input | | support | of supportable |
| Class | power | | requirements | devices |
| Class 1 | 2 | W | 1 x Class 1 | 1 x Class 1 |
| Class 2 | 10 | W | 1 x Class 3 | 2 x Class 2 |
| Class 3 | 16 | W | 1 x Class 4 | 2 x Class 3 |
| Class 4 | 33 | W | 1 x Class 5 | 3 x Class 3 |
| Class 5 | 50 | W | 1 x Class 6 | 4 x Class 3 |
| Class 6 | 70 | W | 1 x Class 6 | 5 x Class 3 |

The classes shown in Table 1 are merely an embodiment, and new classes may be added or existing classes may be deleted. It should also be noted that the maximum input power for each class, the minimum category support requirements, and the maximum number of supportable devices may vary depending on the use, shape, and implementation of the wireless power transmitter.

For example, referring to Table 1, when the maximum value of the power P_{TX}_{_}_{IN}_{_}_{COIL} applied to the transmission resonator 140 is greater than or equal to the value of P_{TX}_{_}_{IN}_{_}_{MAX} corresponding to Class 3 and less than the value of P_{TX}_{_}_{IN}_{_}_{MAX} corresponding to Class 4, the class of the wireless power transmitter may be determined as Class 3.

Second, the wireless power transmitter may be identified according to the minimum category support requirements corresponding to the identified class.

Here, the minimum category support requirement may be a supportable number of wireless power receivers corresponding to the highest level category of the wireless power receiver categories which may be supported by the wireless power transmitter of the corresponding class. That is, the minimum category support requirement may be the minimum number of maximum category devices which may be supported by the wireless power transmitter. In this case, the wireless power transmitter may support wireless power receivers of all categories lower than or equal to the maximum category according to the minimum category requirement.

However, if the wireless power transmitter is capable of supporting a wireless power receiver of a category higher than the category specified in the minimum category support requirement, the wireless power transmitter may not be restricted from supporting the wireless power receiver.

For example, referring to Table 1, a wireless power transmitter of Class 3 should support at least one wireless power receiver of Category 5. Of course, in this case, the wireless power transmitter may support a wireless power receiver 100 that falls into a category lower than the category level corresponding to the minimum category support requirement.

It should also be noted that the wireless power transmitter may support a wireless power receiver of a higher level category if it is determined that the category whose level is higher than the category corresponding to the minimum category support requirement can be supported.

Third, the wireless power transmitter may be identified by the maximum number of supportable devices corresponding to the identified class. Here, the maximum number of supportable devices may be identified by the maximum number of supportable wireless power receivers corresponding to the lowest level category among the categories which are supportable in the class—hereinafter, simply referred to as the maximum number of supportable devices.

For example, referring to Table 1, the wireless power transmitter of Class 3 should support up to two wireless power receivers corresponding to Category 3 which is the lowest level category.

However, when the wireless power transmitter is capable of supporting more than the maximum number of devices corresponding to its own class, it is not restricted from supporting more than the maximum number of devices.

The wireless power transmitter according to the present disclosure must perform wireless power transmission within the available power for up to at least the number defined in Table 1 if there is no particular reason not to allow the power transmission request from the wireless power receivers.

In one example, if there is not enough available power to accept the power transmission request the wireless power transmitter may not accept a power transmission request from the wireless power receiver. Alternatively, it may control power adjustment of the wireless power receiver.

In another example, when the wireless power transmitter accepts a power transmission request, it may not accept a power transmission request from a corresponding wireless power receiver if the number of acceptable wireless power receivers is exceeded.

In another example, the wireless power transmitter may not accept a power transmission request from a wireless power receiver if the category of the wireless power receiver requesting power transmission exceeds a category level that is supportable in the class of the wireless power transmitter.

In another example, the wireless power transmitter may not accept a power transmission request of the wireless power receiver if the internal temperature thereof exceeds a reference value.

In particular, the wireless power transmitter according to the present disclosure may perform the power redistribution procedure based on the currently available power amount. The power redistribution procedure may be performed further considering at least one of a category, a wireless power reception state, a required power amount, a priority, and a consumed power amount of a wireless power receiver for power transmission, which will be described later.

Information on the at least one of the category, wireless power reception state, required power amount, priority, and consumed power amount of the wireless power receiver may be transmitted from the wireless power receiver to the wireless power transmitter through at least one control signal over an out-of-band communication channel.

Once the power redistribution procedure is completed, the wireless power transmitter may transmit the power redistribution result to the corresponding wireless power receiver via out-of-band communication.

The wireless power receiver may recalculate the estimated time required to complete charging based on the received power redistribution result and transmit the re-calculation result to the microprocessor of a connected electronic device. Subsequently, the microprocessor may control the display provided to the electronic device to display the recalculated estimated charging completion time. At this time, the displayed estimated charging completion time may be controlled so as to disappear after being displayed for a predetermined time.

According to another embodiment of the present disclosure, when the estimated time required to complete charging is recalculated, the microprocessor may control the recalculated estimated charging completion to be displayed together with information on the reason for re-calculation. To this end, the wireless power transmitter may also transmit the information on the reason for occurrence of power redistribution to the wireless power receiver when it transmits the power redistribution result.

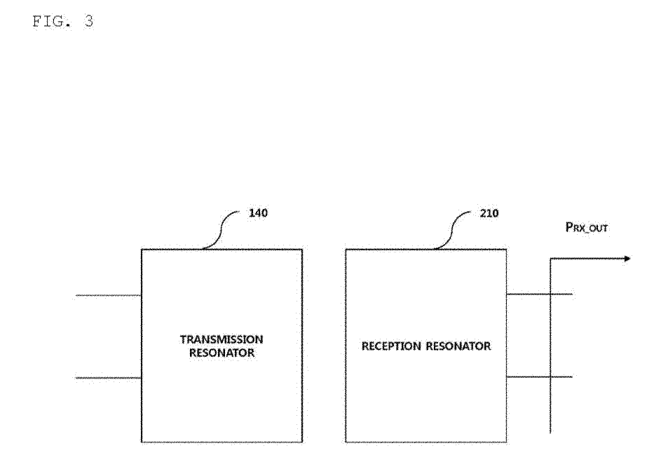

FIG. 3 is a diagram illustrating a type and characteristics of a wireless power receiver in an electromagnetic resonance scheme according to an embodiment of the present disclosure.

As shown in FIG. 3, the average output power P_{RX}_{_}_{OUT} of the reception resonator 210 is a real number value calculated by dividing the product of the voltage V(t) and the current I(t) output by the reception resonator 210 for a unit time by the unit time.

The category of the wireless power receiver may be defined based on the maximum output power P_{RX}_{_}_{OUT}_{_}_{MAX} of the reception resonator 210, as shown in Table 2 below.

TABLE 2

| | Maximum | | |
|---|---|---|---|
| | input | | Application |
| Category | power | | example |
| Category 1 | TBD | | Bluetooth |
| | | | handset |
| Category 2 | 3.5 | W | Feature phone |
| Category 3 | 6.5 | W | Smartphone |
| Category 4 | 13 | W | Tablet |
| Category 5 | 25 | W | Small laptop |
| Category 6 | 37.5 | W | Laptop |
| Category 6 | 50 | W | TBD |

For example, if the charging efficiency at the load stage is 80% or more, the wireless power receiver of Category 3 may supply power of 5 W to the charging port of the load.

The categories disclosed in Table 2 are merely an embodiment, and new categories may be added or existing categories may be deleted. It should also be noted that the maximum output power for each category and application examples shown in Table 2 may vary depending on the use, shape and implementation of the wireless power receiver.

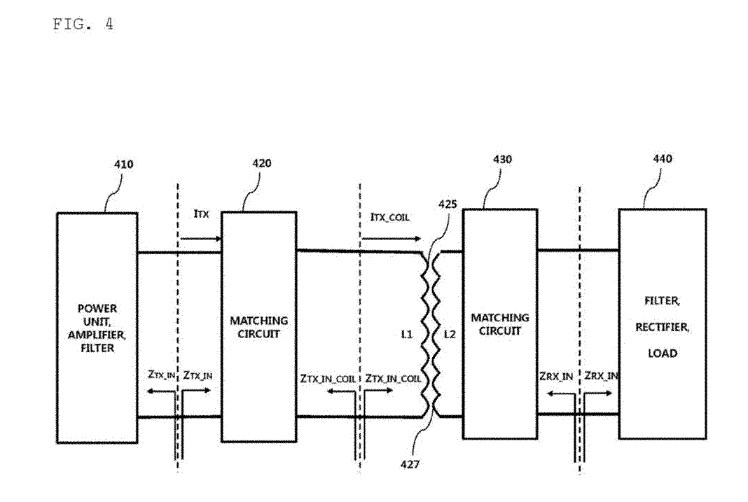

FIG. 4 shows an equivalent circuit diagram of a wireless power transmission system supporting an electromagnetic resonance scheme according to an embodiment of the present disclosure.

Specifically, FIG. 4 shows interface points on the equivalent circuit at which reference parameters, which will be described later, are measured.

Hereinafter, meanings of the reference parameters shown in FIG. 4 will be briefly described.

I_{TX} and I_{TX}_{_}_{COIL} denote the RMS (Root Mean Square) current applied to the matching circuit (or matching network) 420 of the wireless power transmitter and the RMS current applied to the transmission resonator coil 425 of the wireless power transmitter.

Z_{TX}_{_}_{IN} denotes the input impedance at the rear end of the power unit/amplifier/filter 410 of the wireless power transmitter and the input impedance at the front end of the matching circuit 420.

Z_{TX}_{_}_{IN}_{_}_{COIL} denotes the input impedance at the rear end of the matching circuit 420 and the front end of the transmission resonator coil 425.

L1 and L2 denote the inductance value of the transmission resonator coil 425 and the inductance value of the reception resonator coil 427, respectively.

Z_{RX}_{_}_{IN} denotes the input impedance at the rear end of the matching circuit 430 of the wireless power receiver and the front end of the filter/rectifier/load 440 of the wireless power receiver.

The resonant frequency used in the operation of the wireless power transmission system according to an embodiment of the present disclosure may be 6.78 MHz±15 kHz.

In addition, the wireless power transmission system according to an embodiment may provide simultaneous charging (i.e., multi-charging) for a plurality of wireless power receivers. In this case, even if a wireless power receiver is newly added or removed, the received power variation of the remaining wireless power receivers may be controlled so as not to exceed a predetermined reference value. For example, the received power variation may be ±10%, but embodiments are not limited thereto. If it is not possible to control the received power variation not to exceed the reference value, the wireless power transmitter may not accept the power transmission request from the newly added wireless power receiver.

The condition for maintaining the received power variation is that the existing wireless power receivers should not overlap a wireless power receiver that is added to or removed from the charging area.

When the matching circuit 430 of the wireless power receiver is connected to the rectifier, the real part of Z_{TX}_{_}_{IN} may be inversely proportional to the load resistance of the rectifier (hereinafter, referred to as R_{RECT}). That is, an increase in R_{RECT} may decrease Z_{TX}_{_}_{IN}, and a decrease in R_{RECT} may increase Z_{TX}_{_}_{IN}.

The resonator coupling efficiency according to the present disclosure may be a maximum power reception ratio calculated by dividing the power transmitted from the reception resonator coil to the load 440 by the power carried in the resonant frequency band in the transmission resonator coil 425. The resonator coupling efficiency between the wireless power transmitter and the wireless power receiver may be calculated when the reference port impedance Z_{TX}_{_}_{IN} of the transmission resonator and the reference port impedance Z_{RX}_{_}_{IN} of the reception resonator are perfectly matched.

Table 3 below is an example of the minimum resonator coupling efficiencies according to the classes of the wireless power transmitter and the classes of the wireless power receiver according to an embodiment of the present disclosure.

TABLE 3

| | Category | Category | Category | Category | Category | Category | Category |
|---|---|---|---|---|---|---|---|
| | 1 | 2 | 3 | 4 | 5 | 6 | 7 |
| Class 1 | N/A | N/A | N/A | N/A | N/A | N/A | N/A |
| Class 2 | N/A | 74% (−1.3) | 74% (−1.3) | N/A | N/A | N/A | N/A |
| Class 3 | N/A | 74% (−1.3) | 74% (−1.3) | 76% (−1.2) | N/A | N/A | N/A |
| Class 4 | N/A | 50% (−3) | 65% (−1.9) | 73% (−1.4) | 73% (−1.2) | N/A | N/A |
| Class 5 | N/A | 40% (−4) | 60% (−2.2) | 63% (−2) | 73% (−1.4) | 76% (−1.2) | N/A |
| Class 5 | N/A | 30% (−5.2) | 50% (−3) | 54% (−2.7) | 63% (−2) | 73% (−1.4) | 76% (−1.2) |

When a plurality of wireless power receivers is used, the minimum resonator coupling efficiencies corresponding to the classes and categories shown in Table 3 may increase.

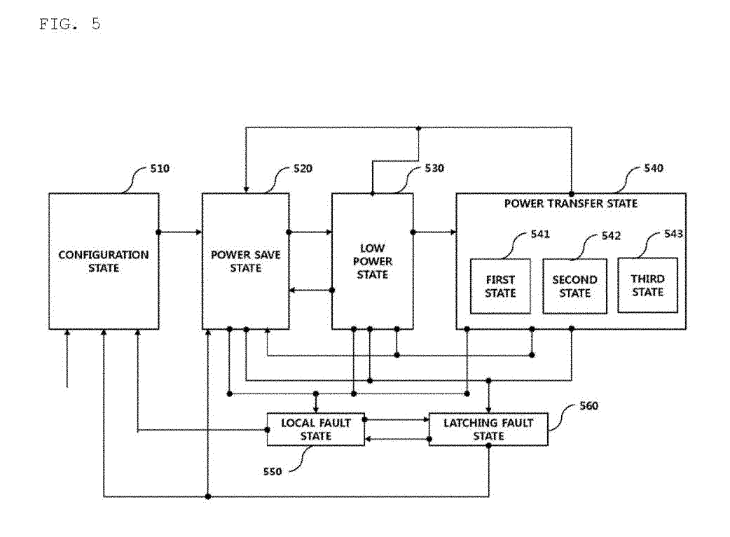

FIG. 5 is a state transition diagram illustrating a state transition procedure in a wireless power transmitter supporting an electromagnetic resonance scheme according to an embodiment of the present disclosure.

Referring to FIG. 5, the states of the wireless power transmitter may include a configuration state 510, a power save state 520, a low power state 530, a power transfer state 540, a local fault state 550, and a latching fault state 560.

When power is applied to the wireless power transmitter, the wireless power transmitter may transition to the configuration state 510. The wireless power transmitter may transition to a power save state 520 when a predetermined reset timer expires in the configuration state 510 or the initialization procedure is completed.

In the power save state 520, the wireless power transmitter may generate a beacon sequence and transmit the same through a resonant frequency band.

Here, the wireless power transmitter may control the beacon sequence to be initiated within a predetermined time after entering the power save state 520. For example, the wireless power transmitter may control the beacon sequence to be initiated within 50 ms after transition to the power save state 520. However, embodiments are not limited thereto.

In the power save state 520, the wireless power transmitter may periodically generate and transmit a first beacon sequence for sensing a wireless power receiver, and sense change in impedance of the reception resonator, that is, load variation. Hereinafter, for simplicity, the first beacon and the first beacon sequence will be referred to as a short beacon and a short beacon sequence, respectively.

In particular, the short beacon sequence may be repeatedly generated and transmitted at a constant time interval t_{CYCLE} during a short period t_{SHORT}_{_}_{BEACON} such that the standby power of the wireless power transmitter may be saved until a wireless power receiver is sensed. For example, t_{SHORT}_{_}_{BEACON} may be set to 30 ms or less, and t_{CYCLE} may be set to 250 ms±5 ms. In addition, the current intensity of the short beacon may be greater than a predetermined reference value, and may be gradually increased during a predetermined time period. For example, the minimum current intensity of the short beacon may be set to be sufficiently large such that a wireless power receiver of Category 2 or a higher category in Table 2 above may be sensed.

The wireless power transmitter according to the present disclosure may be provided with a predetermined sensing means for sensing change in reactance and resistance of the reception resonator according to the short beacon.

In addition, in the power save state 520, the wireless power transmitter may periodically generate and transmit a second beacon sequence for providing sufficient power necessary for booting and response of the wireless power receiver. Hereinafter, for simplicity, the second beacon and the second beacon sequence will be referred to as a long beacon and a long beacon sequence, respectively.

That is, the wireless power receiver may broadcast a predetermined response signal over an out-of-band communication channel when booting is completed through the second beacon sequence.

In particular, the long beacon sequence may be generated and transmitted at a constant time interval t_{LONG}_{_}_{BEACON}_{_}_{PERIOD} during a relatively long period t_{LONG}_{_}_{BEACON} compared to the short beacon to supply sufficient power necessary for booting the wireless power receiver. For example, t_{LONG}_{_}_{BEACON} may be set to 105 ms+5 ms, and t_{LONG}_{_}_{BEACON}_{_}_{PERIOD} may be set to 850 ms. The current intensity of the long beacon may be stronger than the current intensity of the short beacon. In addition, the long beacon may maintain the power of a certain intensity during the transmission period.

Thereafter, the wireless power transmitter may wait to receive a predetermined response signal during the long beacon transmission period after change in impedance of the reception resonator is sensed. Hereinafter, for simplicity, the response signal will be referred to as an advertisement signal. Here, the wireless power receiver may broadcast the advertisement signal in an out-of-band communication frequency band that is different from the resonant frequency band.

In one example, the advertisement signal may include at least one or any one of message identification information for identifying a message defined in the out-of-band communication standard, a unique service or wireless power receiver identification information for identifying whether the wireless power receiver is legitimate or compatible with the wireless power transmitter, information about the output power of the wireless power receiver, information about the rated voltage/current applied to the load, antenna gain information about the wireless power receiver, information for identifying the category of the wireless power receiver, wireless power receiver authentication information, information about whether or not the overvoltage protection function is provided, and version information about the software installed on the wireless power receiver.

Upon receiving the advertisement signal, the wireless power transmitter may establish an out-of-band communication link with the wireless power receiver after transitioning from the power save state 520 to the low power state 530. Subsequently, the wireless power transmitter may perform the registration procedure for the wireless power receiver over the established out-of-band communication link. For example, if the out-of-band communication is Bluetooth low-power communication, the wireless power transmitter may perform Bluetooth pairing with the wireless power receiver and exchange at least one of the state information, characteristic information, and control information about each other via the paired Bluetooth link.

If the wireless power transmitter transmits a predetermined control signal for initiating charging via out-of-band communication, i.e., a predetermined control signal for requesting that the wireless power receiver transmit power to the load, to the wireless power receiver in the low power state 530, the state of the wireless power transmitter may transition from the low power state 530 to the power transfer state 540.

If the out-of-band communication link establishment procedure or registration procedure is not normally completed in the low power state 530, the wireless power transmitter may transition from the low power state 530 to the power save state 520.

A separate independent link expiration timer by which the wireless power transmitter may connect to each wireless power receiver may be driven, and the wireless power receiver may transmit a predetermined message for announcing its presence to the wireless power transmitter in a predetermined time cycle before the link expiration timer expires. The link expiration timer is reset each time the message is received. If the link expiration timer does not expire, the out-of-band communication link established between the wireless power receiver and the wireless power receiver may be maintained.

If all of the link expiration timers corresponding to the out-of-band communication link established between the wireless power transmitter and the at least one wireless power receiver have expired in the low power state 530 or the power transfer state 540, the wireless power transmitter may transition to the power save state 520.

In addition, the wireless power transmitter in the low power state 530 may drive a predetermined registration timer when a valid advertisement signal is received from the wireless power receiver. When the registration timer expires, the wireless power transmitter in the low power state 530 may transition to the power save state 520. At this time, the wireless power transmitter may output a predetermined notification signal notifying that registration has failed through a notification display means (including, for example, an LED lamp, a display screen, and a beeper) provided in the wireless power transmitter.

Further, in the power transfer state 540, when charging of all connected wireless power receivers is completed, the wireless power transmitter may transition to the low power state 530.

In particular, the wireless power receiver may allow registration of a new wireless power receiver in states other than the configuration state 510, the local fault state 550, and the latching fault state 560.

In addition, the wireless power transmitter may dynamically control the transmit power based on the state information received from the wireless power receiver in the power transfer state 540.

Here, the receiver state information transmitted from the wireless power receiver to the wireless power transmitter may include at least one of required power information, information on the voltage and/or current measured at the rear end of the rectifier, charge state information, information indicating the overcurrent, overvoltage and/or overheated state, and information indicating whether or not a means for cutting off or reducing power transferred to the load according to the overcurrent or the overvoltage is activated. The receiver state information may be transmitted with a predetermined periodicity or transmitted every time a specific event is generated. In addition, the means for cutting off or reducing the power transferred to the load according to the overcurrent or overvoltage may be provided using at least one of an ON/OFF switch and a Zener diode.

According to another embodiment, the receiver state information transmitted from the wireless power receiver to the wireless power transmitter may further include at least one of information indicating that an external power source is connected to the wireless power receiver by wire and information indicating that the out-of-band communication scheme has changed (e.g., the communication scheme may change from NFC (Near Field Communication) to BLE (Bluetooth Low Energy) communication).

According to another embodiment of the present disclosure, a wireless power transmitter may adaptively determine the intensity of power to be received by each wireless power receiver based on at least one of the currently available power of the power transmitter, the priority of each wireless power receiver, or the number of connected wireless power receivers. Here, the power intensity of each wireless power receiver may be determined as a share of power to be received with respect to the maximum power that may be processed by the rectifier of the corresponding wireless power receiver.

Thereafter, the wireless power transmitter may transmit, to the wireless power receiver, a predetermined power control command including information about the determined power intensity. Then, the wireless power receiver may determine whether power control can be performed based on the power intensity determined by the wireless power transmitter, and transmit the determination result to the wireless power transmitter through a predetermined power control response message.

According to another embodiment of the present disclosure, a wireless power receiver may transmit predetermined receiver state information indicating whether wireless power control can be performed according to a power control command of a wireless power transmitter before receiving the power control command.

The power transfer state 540 may be any one of a first state 541, a second state 542 and a third state 543 depending on the power reception state of the connected wireless power receiver.

In one example, the first state 541 may indicate that the power reception state of all wireless power receivers connected to the wireless power transmitter is a normal voltage state.

The second state 542 may indicate that the power reception state of at least one wireless power receiver connected to the wireless power transmitter is a low voltage state and there is no wireless power receiver which is in a high voltage state.

The third state 543 may indicate that the power reception state of at least one wireless power receiver connected to the wireless power transmitter is a high voltage state.

When a system error is sensed in the power save state 520, the low power state 530, or the power transfer state 540, the wireless power transmitter may transition to the latching fault state 560.

The wireless power transmitter in the latching fault state 560 may transition to either the configuration state 510 or the power save state 520 when it is determined that all connected wireless power receivers have been removed from the charging area.

In addition, when a local fault is sensed in the latching fault state 560, the wireless power transmitter may transition to the local fault state 550. Here, the wireless power transmitter in the local fault state 550 may transition back to the latching fault state 560 when the local fault is released.

On the other hand, in the case where the wireless power transmitter transitions from any one state among the configuration state 510, the power save state 520, the low power state 530, and the power transfer state 540 to the local fault state 550, the wireless power transmitter may transition to the configuration state 510 once the local fault is released.

The wireless power transmitter may interrupt the power supplied to the wireless power transmitter once it transitions to the local fault state 550. For example, the wireless power transmitter may transition to the local fault state 550 when a fault such as overvoltage, overcurrent, or overheating is sensed. However, embodiments are not limited thereto.

In one example, the wireless power transmitter may transmit, to at least one connected wireless power receiver, a predetermined power control command for reducing the intensity of power received by the wireless power receiver when overcurrent, overvoltage, or overheating is sensed.

In another example, the wireless power transmitter may transmit, to at least one connected wireless power receiver, a predetermined control command for stopping charging of the wireless power receiver when overcurrent, overvoltage, or overheating is sensed.

Through the above-described power control procedure, the wireless power transmitter may prevent damage to the device due to overvoltage, overcurrent, overheating, or the like.

If the intensity of the output current of the transmission resonator is greater than or equal to a reference value, the wireless power transmitter may transition to the latching fault state 560. The wireless power transmitter that has transitioned to the latching fault state 560 may attempt to make the intensity of the output current of the transmission resonator less than or equal to a reference value for a predetermined time. Here, the attempt may be repeated a predetermined number of times. If the latching fault state 560 is not released despite repeated execution, the wireless power transmitter may send, to the user, a predetermined notification signal indicating that the latching fault state 560 is not released, using a predetermined notification means. In this case, when all of the wireless power receivers positioned in the charging area of the wireless power transmitter are removed from the charging area by the user, the latching fault state 560 may be released.

On the other hand, if the intensity of the output current of the transmission resonator falls below the reference value within a predetermined time, or if the intensity of the output current of the transmission resonator falls below the reference value during the predetermined repetition, the latching fault state 560 may be automatically released. In this case, the wireless power transmitter may automatically transition from the latching fault state 560 to the power save state 520 to perform the sensing and identification procedure for a wireless power receiver again.

The wireless power transmitter in the power transfer state 540 may transmit continuous power and adaptively control the transmit power based on the state information on the wireless power receiver and predefined optimal voltage region setting parameters.

For example, the predefined optimal voltage region setting parameters may include at least one of a parameter for identifying a low voltage region, a parameter for identifying an optimum voltage region, a parameter for identifying a high voltage region, and a parameter for identifying an overvoltage region.

The wireless power transmitter may increase the transmit power if the power reception state of the wireless power receiver is in the low voltage region, and reduce the transmit power if the power reception state is in the high voltage region.

The wireless power transmitter may also control the transmit power to maximize power transmission efficiency.

The wireless power transmitter may also control the transmit power such that the deviation of the amount of power required by the wireless power receiver is less than or equal to a reference value.

In addition, the wireless power transmitter may stop transmitting power when the output voltage of the rectifier of the wireless power receiver reaches a predetermined overvoltage region, namely, when overvoltage is sensed.

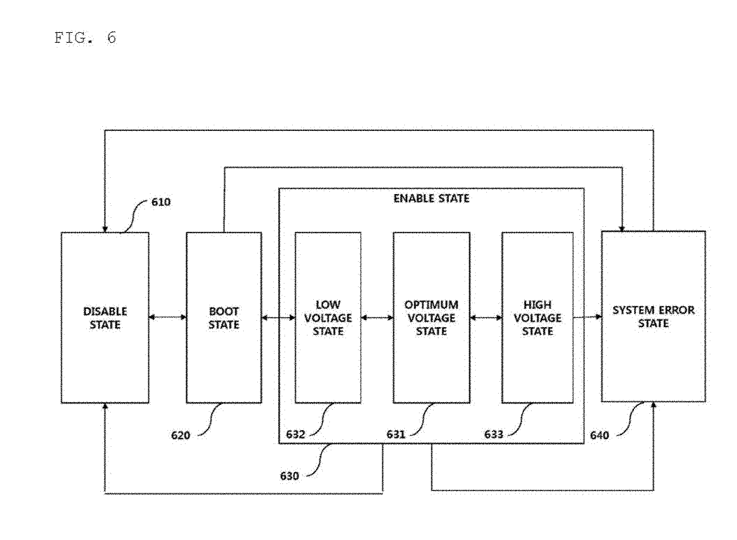

FIG. 6 is a state transition diagram illustrating a state transition procedure of a wireless power receiver in an electromagnetic resonance scheme according to an embodiment of the present disclosure.

Referring to FIG. 6, the states of the wireless power receiver may include a disable state 610, a boot state 620, an enable state (or on state) 630 and a system error state 640.

The state of the wireless power receiver may be determined based on the intensity of the output voltage at the rectifier end of the wireless power receiver (hereinafter referred to as V_{RECT} for simplicity).

The enable state 630 may be divided into an optimum voltage 631, a low voltage state 632 and a high voltage state 633 according to the value of V_{RECT}.

The wireless power receiver in the disable state 610 may transition to the boot state 620 if the measured value of V_{RECT} is greater than or equal to the predefined value of V_{RECT}_{_}_{BOOT}.

In the boot state 620, the wireless power receiver may establish an out-of-band communication link with a wireless power transmitter and wait until the value of V_{RECT} reaches the power required at the load stage.

When it is sensed that the value of V_{RECT} has reached the power required at the load stage, the wireless power receiver in the boot state 620 may transition to the enable state 630 and begin charging.

The wireless power receiver in the enable state 630 may transition to the boot state 620 when it is sensed that charging is completed or interrupted.

In addition, the wireless power receiver in the enable state 630 may transition to the system error state 640 when a predetermined system error is sensed. Here, the system error may include overvoltage, overcurrent, and overheating, as well as other predefined system error conditions.

In addition, the wireless power receiver in the enable state 630 may transition to the disable state 610 if the value of V_{RECT} falls below the value of V_{RECT}_{_}_{BOOT}.

In addition, the wireless power receiver in the boot state 620 or the system error state 640 may transition to the disable state 610 if the value of V_{RECT} falls below the value of V_{RECT}_{_}_{BOOT}.

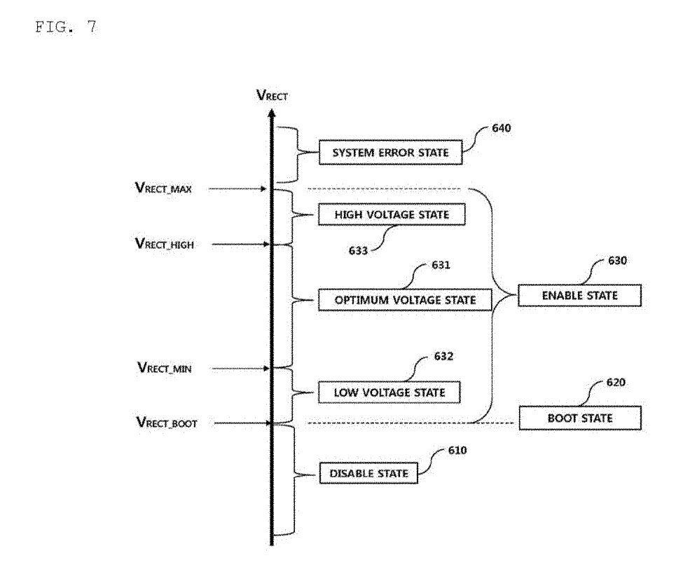

Hereinafter, state transition of the wireless power receiver in the enable state 630 will be described in detail with reference to FIG. 7.

FIG. 7 illustrates operation regions of a wireless power receiver according to V_{RECT} in an electromagnetic resonance scheme according to an embodiment of the present disclosure.

Referring to FIG. 7, if the value of V_{RECT} is less than a predetermined value of V_{RECT}_{_}_{BOOT}, the wireless power receiver is maintained in the disable state 610.

Thereafter, when the value of V_{RECT} is increased beyond V_{RECT}_{_}_{BOOT} the wireless power receiver may transition to the boot state 620 and broadcast an advertisement signal within a predetermined time. Thereafter, when the advertisement signal is sensed by the wireless power transmitter, the wireless power transmitter may transmit a predetermined connection request signal for establishing an out-of-band communication link to the wireless power receiver.

Once the out-of-band communication link is normally established and successfully registered, the wireless power receiver may wait until the value of V_{RECT} reaches the minimum output voltage of the rectifier for normal charging (hereinafter referred to as V_{RECT}_{_}_{MIN} for simplicity).

If the value of V_{RECT} exceeds V_{RECT}_{_}_{MIN}, the wireless power receiver may transition from the boot state 620 to the enable state 630 and may begin charging the load.

If the value of V_{RECT} in the enable state 630 exceeds a predetermined reference value V_{RECT}_{_}_{MAX} for determining overvoltage, the wireless power receiver may transition from the enable state 630 to the system error state 640.

Referring to FIG. 7, the enable state 630 may be divided into the low voltage state 632, the optimum voltage 631 and the high voltage state 633 according to the value of V_{RECT}.

The low voltage state 632 may refer to a state in which V_{RECT}_{_}_{BOOT}≤V_{RECT}≤V_{RECT}_{_}_{MIN}, the optimum voltage state 631 may refer to a state in which V_{RECT}_{_}_{MIN}<V_{RECT}≤V_{RECT}_{_}_{HIGH}, and the high voltage state 633 may refer to a state in which V_{RECT}_{_}_{HIGH}<V_{RECT}≤V_{RECT}_{_}_{MAX}.

In particular, the wireless power receiver having transitioned to the high voltage state 633 may suspend the operation of cutting off the power supplied to the load for a predetermined time (hereinafter referred to as a high voltage state maintenance time for simplicity). The high voltage state maintenance time may be predetermined so as not to cause damage to the wireless power receiver and the load in the high voltage state 633.

When the wireless power receiver transitions to the system error state 640, it may transmit a predetermined message indicating occurrence of overvoltage to the wireless power transmitter through the out-of-band communication link within a predetermined time.

The wireless power receiver may also control the voltage applied to the load using an overvoltage interruption means provided to prevent damage to the load due to the overvoltage in the system fault state 630. Here, an ON/OFF switch and/or a Zener diode may be used as the overvoltage interruption means.

Although a method and means for coping with a system error in a wireless power receiver when overvoltage is generated and the wireless power receiver transitions to the system error state 640 have been described in the above embodiment, this is merely an embodiment. In other embodiments, the wireless power receiver may transition to the system error state due to overheating, overcurrent, and the like.

As an example, in the case where the wireless power receiver transitions to the system error state due to overheating, the wireless power receiver may transmit a predetermined message indicating the occurrence of overheating to the wireless power transmitter. In this case, the wireless power receiver may drive a cooling fan or the like to reduce the internally generated heat.

According to another embodiment of the present disclosure, a wireless power receiver may receive wireless power in conjunction with a plurality of wireless power transmitters. In this case, the wireless power receiver may transition to the system error state 640 if it is determined that the wireless power transmitter from which the wireless power receiver is determined to actually receive wireless power is different from the wireless power transmitter with which the out-of-band communication link is actually established.

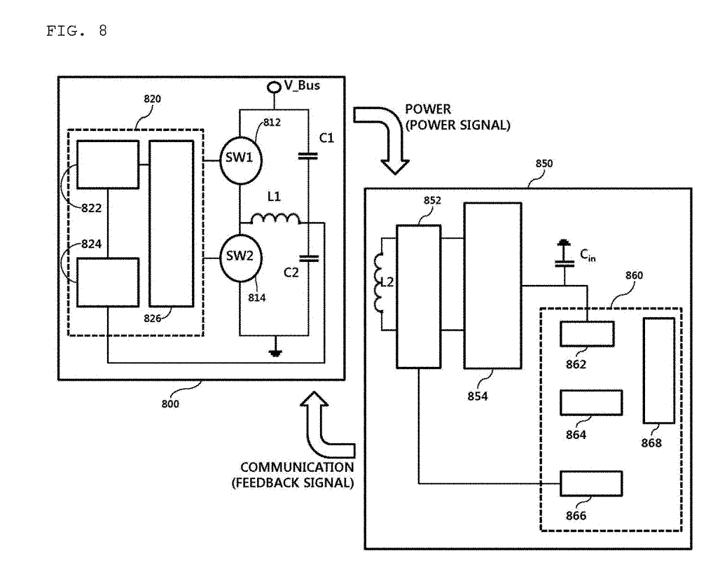

FIG. 8 is a diagram illustrating a wireless charging system in an electromagnetic induction scheme according to an embodiment of the present disclosure.

Referring to FIG. 8, a wireless charging system according to the electromagnetic induction scheme includes a wireless power transmitter 800 and a wireless power receiver 850. By placing an electronic device including the wireless power receiver 850 on the wireless power transmitter 800, the coils of the wireless power transmitter 800 and the wireless power receiver 850 may be coupled by an electromagnetic field.

The wireless power transmitter 800 may modulate a power signal and change the frequency to create an electromagnetic field for power transmission. The wireless power receiver 850 may receive power by demodulating the electromagnetic signal according to the protocol set to be suitable for the wireless communication environment and transmit a predetermined feedback signal to the wireless power transmitter 100 via in-band communication based on the intensity of the received power to control the intensity of the transmit power of the wireless power transmitter 800. For example, the wireless power transmitter 800 may control the operating frequency according to a control signal for power control to increase or decrease the transmit power.

The amount (or increase/decrease) of power transmitted may be controlled using a feedback signal transmitted from the wireless power receiver 850 to the wireless power transmitter 800. Communication between the wireless power receiver 850 and the wireless power transmitter 800 is not limited to in-band communication using the feedback signal described above, but may also be performed using out-of-band communication provided with a separate communication module. For example, short-range wireless communication modules such as a Bluetooth module, a Bluetooth Low Energy (BLE) module, an NFC module, and a ZigBee module may be used.

In the electromagnetic induction scheme, a frequency modulation scheme may be used as a protocol for exchanging state information and control signals between the wireless power transmitter 800 and the wireless power receiver 850. The device identification information, the charging state information, the power control signal, and the like may be exchanged through the protocol.

As shown in FIG. 8, the wireless power transmitter 800 according to an embodiment of the present disclosure includes a signal generator 820 for generating a power signal, a coil L1 and capacitors C1 and C2 positioned between the power supply terminals V_Bus and GND capable of sensing a feedback signal transmitted from the wireless power receiver 850, and switches SW1 and SW2 whose operation is controlled by the signal generator 820. The signal generator 820 may include a demodulator 824 for demodulating a feedback signal transmitted through the coil L1, a frequency driver 826 for changing the frequency, and a transmission controller 822 for controlling the modulator 824 and the frequency driver 826. The feedback signal transmitted through the coil L1 may be demodulated by the demodulation unit 824 and then input to the transmission controller 822. The transmission controller 822 may control the frequency driver 826 based on the demodulated signal to change the frequency of the power signal transmitted through the coil L1.

The wireless power receiver 850 may include a modulator 852 for transmitting a feedback signal through a coil L2, a rectifier 854 for converting an AC signal received through the coil L2 into a DC signal, and a reception controller 860 for controlling the modulator 852 and the rectifier 854. The reception controller 860 may include a power supplier 862 for supplying power necessary for operation of the rectifier 854 and the wireless power receiver 850, and a DC-DC converter 864 for changing the DC output voltage of the rectifier 854 to a DC voltage satisfying the charging requirements of a charging target (a load 868), a load 868 for outputting the converted power, and a feedback communication unit 866 for generating a feedback signal for providing a receive power state and a charging target state to the wireless power transmitter 800.

The operation state of the wireless charging system supporting the electromagnetic induction scheme may be broadly classified into a standby state, a signal detection state, an identification state, a power transfer state, and an end-of-charge state. Transition to a different operation state may be performed according to a result of feedback communication between the wireless power receiver 850 and the wireless power transmitter 800. Transition between the standby state and the signal detection state may be performed using a predetermined receiver detection method for detecting presence of the wireless power receiver 850.

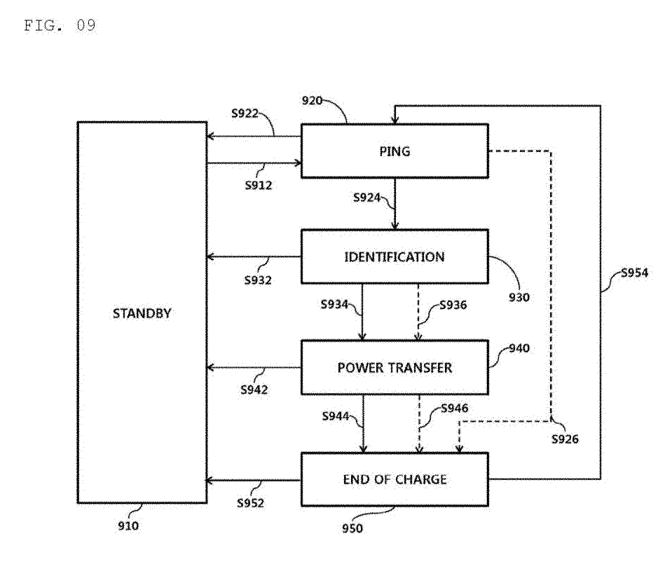

FIG. 9 is a state transition diagram of a wireless power transmitter supporting an electromagnetic induction scheme according to an embodiment of the present disclosure.

As shown in FIG. 9, the operation states of the wireless power transmitter may be broadly divided into a standby state (STANDBY) 910, a signal detection state (PING) 920, an identification state (IDENTIFICATION) 930, a power transfer state (POWER TRANSFER) 940 and an end-of-charge state (END OF CHARGE) 950.

Referring to FIG. 9, during the standby state 910, the wireless power transmitter monitors the charging area to sense if a chargeable reception device is positioned in the charging area. The wireless power transmitter may monitor change in magnetic field, capacitance, or inductance to sense a chargeable reception device. When a chargeable reception device is found, the wireless power transmitter may transition from the standby state 910 to the signal detection state 920 (S912).

In the signal detection state 920, the wireless power transmitter may connect to the chargeable reception device and check if the reception device is using a valid wireless charging technique. In addition, in the signal detection state 220, the wireless power transmitter may perform an operation to distinguish other devices that generate dark current (parasitic current).

In the signal detection state 920, the wireless power transmitter may also send a digital ping having a structure according to a predetermined frequency and time to connect to a chargeable reception device. If a sufficient power signal is transferred from the wireless power transmitter to the wireless power receiver, the wireless power receiver may respond by modulating the power signal according to the protocol set in the electromagnetic induction scheme. If a valid signal according to the wireless charging technique used by the wireless power transmitter is received, the wireless power transmitter may transition from the signal detection state 920 to the identification state 930 without interrupting transmission of the power signal (S924). A wireless power transmitter that does not support the operation in the identification state 930 may transition to the power transfer state 940 (S924 and S934).

If the wireless power transmitter receives an end-of-charge signal from the wireless power receiver, the wireless power transmitter may transition from the signal detection state 920 to the end-of-charge state 950 (S926).

If no response from the wireless power receiver is sensed in the signal detection state 920, for example, if no feedback signal is received for a predetermined time, the wireless power transmitter may interrupt transmission of the power signal and transition to the standby state 910 (S922).

The identification state 930 may be selectively included depending on the wireless power transmitter.

Unique receiver identification information may be pre-allocated and maintained for each wireless power receiver. When a digital ping is sensed, the wireless power receiver needs to inform the wireless power transmitter that the corresponding device is chargeable according to a specific wireless charging technique. To check such receiver identification information, the wireless power receiver may transmit unique identification information thereof to the wireless power transmitter through feedback communication.

A wireless power transmitter supporting the identification state 930 may determine validity of the receiver identification information sent from the wireless power receiver. If it is determined that the received receiver identification information is valid, the wireless power transmitter may transition to the power transfer state 940 (S936). If the received receiver identification information is not valid or validity is not determined within a predetermined time, the wireless power transmitter may interrupt transmission of the power signal and transition to the standby state 910 (S932).

In the power transfer state 940, the wireless power transmitter may control the intensity of the transmit power based on the feedback signal received from the wireless power receiver. In addition, the wireless power transmitter in the power transfer state 940 may verify that there is no violation of an acceptable operation region and tolerance limit that may arise, for example, by detection of a new device.

If a predetermined end-of-charge signal is received from the wireless power receiver in the power transfer state 940, the wireless power transmitter may stop transmitting the power signal and transition to the end-of-charge state 950 (S946). In addition, if the internal temperature exceeds a predetermined value during operation in the power transfer state 940, the wireless power transmitter may interrupt transmission of the power signal and may transition to the end-of-charge state 950 (S944).

In addition, if a system error or the like is sensed in the power transfer state 940, the wireless power transmitter may stop transmitting the power signal and transition to the standby state 910 (S942).

A new charging procedure may be resumed when a reception device to be charged is sensed in the charging area of the wireless power transmitter.

As described above, the wireless power transmitter may transition to the end-of-charge state 950 when the end-of-charge signal is input from the wireless power receiver or the temperature exceeds a predetermined range during operation.

If transition to the end-of-charge state 950 is caused by an end-of-charge signal, the wireless power transmitter may interrupt transmission of the power signal and wait for a certain time. Here, the certain time may vary depending on components such as coils provided in the wireless power transmitter, the range of the charging area, the allowable limit of the charging operation, or the like, in order to transmit the power signal in the electromagnetic induction scheme. After a certain time elapses in the end-of-charge state 950, the wireless power transmitter may transition to the signal detection state 920 to connect to the wireless power receiver positioned on the charging surface (S954). The wireless power transmitter may also monitor the charging surface for a certain time to recognize whether the wireless power reception device is removed. If it is sensed that the wireless power reception device has been removed from the charging surface, the wireless power transmission device may transition to the standby state 910 (S952).

If transition to the end-of-charge state S950 is performed due to the internal temperature of the wireless power transmitter, the wireless power transmitter may interrupt power transmission and monitor change in internal temperature. If the internal temperature falls within a certain range or to a certain value, the wireless power transmitter may transition to the signal detection state 920 (S954). The temperature range or value for transitioning the state of the wireless power transmitter may vary depending on the technology and method for manufacturing the wireless power transmitter. While monitoring change in temperature, the wireless power transmitter may monitor the charging surface to recognize if the wireless power reception device is removed. If it is sensed that the wireless power reception device has been removed from the charging surface, the wireless power transmitter may transition to the standby state 910 (S952).

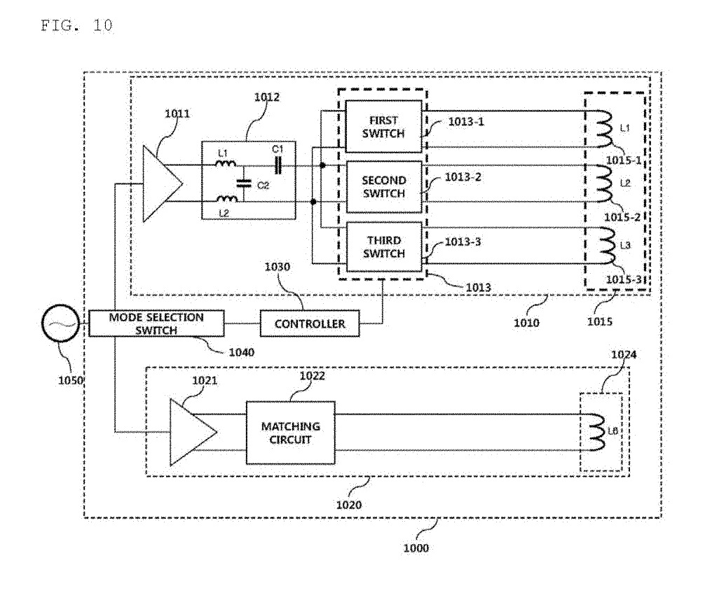

FIG. 10 is a block diagram illustrating a structure of a wireless power transmitter supporting multiple modes according to an embodiment of the present disclosure.

Referring to FIG. 10, the wireless power transmitter 1000 may include an induction transmitter 1010, a resonant transmitter 1020, a controller 1030, and a mode selection switch 1040, but embodiments are not limited thereto.

The mode selection switch 1040 may be connected to a power source 1050 and may perform a switching function to allow the power applied from the power source 1050 to be transmitted to the induction transmitter 1010 or the resonant transmitter 1020 under control of the controller 1030.

In another embodiment of the present disclosure, the power source 1050 may be a battery that supplies power via an external power terminal or is mounted in the wireless power transmitter 1000.

The induction transmitter 1010 may include an induction inverter 1011, a resonant circuit 1012, a transmission induction coil selection circuit 1013 and transmission induction coils (L1 to L3) 1015. A magnet for alignment between the transmission induction coils 1015 and the reception induction coil mounted on the receiver may be further included depending on the design of the induction transmitter 1010 according to an embodiment of the present disclosure.

The induction inverter 1011 may convert a direct current (DC) waveform applied through the mode selection switch 1040 into an alternating current (AC) for driving the resonant circuit 1012. In the induction inverter 1011, a predetermined operating frequency range and/or duty cycle of a power signal for controlling the amount of transmit power may be defined. That is, the amount of transmit power may be dynamically controlled by changing the operating frequency. The induction inverter 1011 according to an embodiment of the present disclosure may be designed as a half-bridge inverter or a full-bridge inverter depending on the class and purpose of the wireless power transmitter.

The resonant circuit 1012 may be configured by a combination of a series of inductors and capacitors and may be used to resonate the AC waveform received from the induction inverter 1011. For example, referring to FIG. 10, the resonant circuit 1012 may include, without being limited to, two inductors L1 and L2 and two capacitors C1 and C2.

The transmission induction coil selection circuit 1013 may include the same number of switches as the number of transmission induction coils 1015 mounted in the induction transmitter 1010. For example, as shown in FIG. 10, when the number of the transmission induction coils 1015 is three, the transmission induction coil selection circuit 1013 may have first to third switches 1013-1 to 1013-3. Each of the switches constituting the transmission induction coil selection circuit 1013 may function to allow or interrupt electric power to be transmitted to the corresponding coils. When the position of a wireless power receiver is sensed in the charging area, the controller 1030 according to an embodiment of the present disclosure may identify a coil corresponding to the sensed position and control the transmission induction coil selection circuit 1013 such that the power signal can be transmitted only to the identified coil.

The transmission induction coil 1215 may include a plurality of coils. The transmission induction coil 1215 is illustrated in FIG. 10 as having three coils L1 (1015-1), L2 (1015-2) and L3 (1015-3), this is only one embodiment. It should be noted that the transmission induction coil 1215 may be configured to include more or less coils depending on the implementation and use of the wireless power transmitter 1200 in another embodiment of the present disclosure.

The resonant transmitter 1020 may include a resonant inverter 1021, a matching circuit 1022, and transmission resonant coils L4 and 1024. Here, the resonant inverter 1021 and the matching circuit 1022 may correspond to the power conversion unit 120 and the matching circuit 130 of FIG. 1, respectively, and the description of FIG. 1 is applied thereto.

The controller 1030 may control the overall operation of the wireless power transmitter 1000. In particular, the controller 1030 may adaptively determine a power transmission mode based on the characteristics and state of the wireless power receiver, and control the mode selection switch 1040 according to the determined wireless power transmission mode. For example, if the wireless power transmission mode supportable by a wireless power receiver connected to the wireless power transmitter 1000 is determined to be an electromagnetic resonance mode, the controller 1030 may control the mode selection switch 1040 to supply power of the power source 1050 to the resonant transmitter 1020. In another example, if it is determined that the wireless power transmission mode supportable by the wireless power receiver connected to the wireless power transmitter 1000 is an electromagnetic induction mode, the controller 1030 may control the mode selection switch 1040 to supply power of the power source 1050 to the inductive transmitter 1010.

In addition, the controller 1030 may control the induction inverter 1011 and the resonant inverter 1021 to control the strength of the power signal transmitted through the coils.

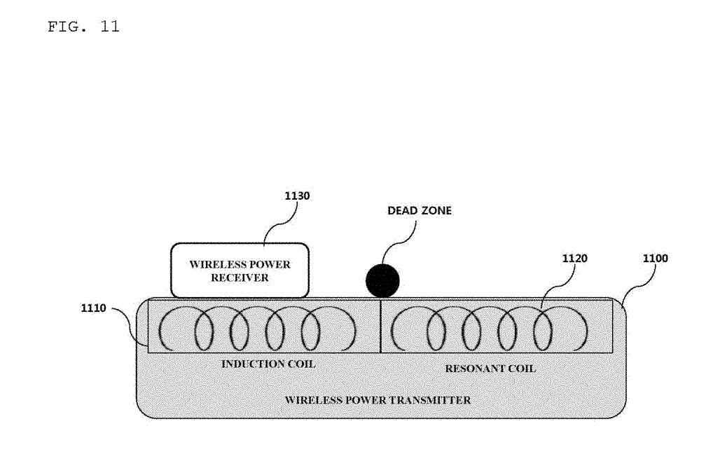

FIG. 11 is a view illustrating a wireless power transmitter supporting multiple modes according to a comparative example of the present disclosure.

Referring to FIG. 11, the wireless power transmitter 1100 is a device that performs a function similar to that of the wireless power transmitter 1000 shown in FIG. 10. The wireless power transmitter 1100 may supply wireless power to the wireless power receiver 1130 located adjacent to the wireless power transmitter 1100.

The wireless power transmitter 1100 includes an induction coil 1110 and a resonant coil 1120. The induction coil 1110 performs a function similar to that of the transmission induction coils (L1 to L3) 1015 shown in FIG. 10, and the resonant coil 1120 performs a function similar to that of the transmission resonant coil (L4) 1024 shown in FIG. 10. That is, each of the induction coil 1110 and the resonant coil 1120 may transfer wireless power to the wireless power receiver 1130.

As shown in FIG. 11, when the induction coil 1110 and the resonant coil 1120 are implemented in the same plane, a dead zone, which is a region where charging cannot be performed in a boundary region between the induction coil 1110 and the resonant coil 1120, may be formed.

If the wireless power receiver 1130 is positioned in the dead zone, neither the induction coil 1110 nor the resonant coil 1120 may sense the wireless power receiver 1130, or wireless power transmission efficiency may be remarkably degraded even if any one of the induction coil 1110 and the resonant coil 1120 senses the wireless power receiver 1130 positioned in the dead zone.

Therefore, the dead zone may greatly deteriorate the quality of the wireless power transmitter 1100 experienced by the user.

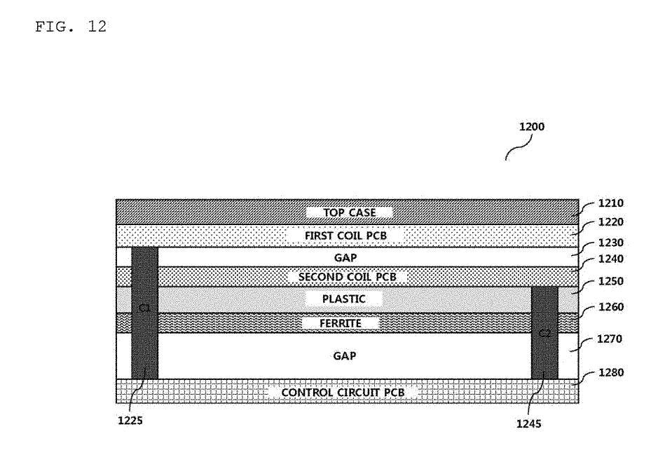

FIG. 12 is a cross-sectional view illustrating a structure of a wireless power transmitter supporting multiple modes according to an embodiment of the present disclosure.

Referring to FIG. 12, the cross section of the wireless power transmitter 1200 may include an upper case 1210, a first coil printed circuit board (PCB) 1220, a first connector (C1) 1225, a gap 1230, a second coil PCB 1240, a second connector (C2) 1245, a plastic part 1250, a ferrite part 1260, a gap 1270, and a control circuit PCB 1280.

The upper case 1210 may define the outer appearance of the wireless power transmitter 1200 and function to protect the internal elements from external force. The position of the upper case 1210 may be the uppermost position and the position of the control circuit PCB 1280 may be the lowest position, but embodiments are not limited thereto.

The first coil PCB 1220 may include a coil having a spiral pattern (a PCB copper pattern). That is, the first coil PCB 1220 may include the transmission induction coils (L1 to L3) and 1015 shown in FIG. 10, and three thermistors for sensing the temperatures of the transmission induction coils (L1 to L3) 1015, respectively. The thermistors include a resistor whose resistance varies with temperature, and outputs an electrical signal corresponding to the temperature of each of the transmission induction coils (L1 to L3) 1015. In another embodiment, the first coil PCB may include a coil formed by winding a coil configured with a single wire or multiple wires by a plurality turns and disposed on a PCB and the PCB. The coil configured with the single wire or the plurality of wires may be connected to a connector attached to the PCB. That is, the first coil PCB 1220 including the single wire or the plurality of wires may include the transmission induction coils (L1 to L3) 1015 shown in FIG. 10, and three thermistors for sensing the temperature of each of the transmission induction coils (L1 to L3) 1015. The thermistors include a resistor whose resistance varies with temperature, and outputs an electrical signal corresponding to the temperature of each of the transmission induction coils (L1 to L3) 1015. The single coil may include a Litz wire. The transmission induction coils (L1 to L3) 1015 may transmit a power signal of a first frequency band to a wireless power receiver coil having a first coupling coefficient. The first coupling coefficient may mean the degree to which the transmission induction coils (L1 to L3) 1015 and the wireless power receiver coil are magnetically linked. When wireless power transmission is normally performed (with an efficiency higher than or equal to about 75%), the coefficient may range from about 0.5 to 1.0.

The first frequency band may be 90 kHz to 300 kHz or 100 kHz to 220 kHz, but embodiments of the present disclosure are not limited thereto.

When the transmission induction coils (L1 to L3) 1015 are formed on the first coil PCB 1220, the charging areas of the transmission induction coils (L1 to L3) 1015 may be over the first coil PCB 1220.

The first connector 1225 may function to electrically connect the first coil PCB 1220 and the control circuit PCB 1280, and the transmission induction coils (L1 to L3) 1015 and the thermistors corresponding to the transmission induction coils (L1 to L3) 1015 may transmit and receive electrical signals to and from the control circuit PCB 1280 via the first connector 1225.

The gap 1230 may be formed between the first coil PCB 1220 and the second coil PCB 1240 and reduce the electrical and magnetic effects between the first coil PCB 1220 and the second coil PCB 1240. In another embodiment, the gap 1230 may be filled with a non-metallic material or non-conductive material, for example, plastics or rubber, in place of the void space. Alternatively, the first coil PCB 1220 may be formed without the gap 1230 with coils disposed on the top surface thereof. Alternatively, the second coil PCB 1240 may be formed without the gap 1230 with coils disposed on the bottom surface thereof. Alternatively, the first coil PCB 1220 may be provided with coils on the top surface thereof, the second coil PCB 1240 may be provided with coils on the bottom surface thereof, and the gap 1230 may not be provided.

The second coil PCB 1240 may include a coil patterned in a spiral structure. Alternatively, the second coil PCB 1240 may include a coil patterned in a symmetrical structure. The second coil PCB 1240 may include coils whish are point-symmetrical or line-symmetrical such that the coils are spaced apart to form a sufficient magnetic field in the pad region. That is, the second coil PCB 1240 may include the transmission resonant coil (L4) 1024 shown in FIG. 10, and may include a sensor for sensing the operation state of the transmission resonant coil (L4) 1024. The sensor may be coupled with the transmission resonant coil (L4) 1024 to sense the intensity of the magnetic field generated in the transmission resonant coil (L4) 1024 and to covert the intensity into an electrical signal to be output. That is, the sensor functions to sense the transmission efficiency of the transmission resonant coil (L4) 1024.

The second coil PCB 1240 may include a coil formed by winding a coil configured with a single wire or multiple wires by a plurality turns and disposed on the PCB and a Litz wire coil, in addition to the coil patterned in the spiral structure.

The transmission resonant coil (L4) 1024) may transmit a power signal of a second frequency band to a wireless power receiver coil having a second coupling coefficient. The second coupling coefficient may mean the degree to which the transmission resonant coil (L4) 1024 and the wireless power receiver coil are magnetically linked. When wireless power transmission is normally performed (with an efficiency higher than or equal to about 55%), the coefficient may range from about 0 to 0.2. Thus, the first coupling coefficient is greater than the second coupling coefficient.

The second frequency band may be 6 MHz to 8 MHz or 6.78 MHz, but embodiments of the present disclosure are not limited thereto. Thus, the first frequency range is below the second frequency range. This means that the maximum frequency of the frequencies belonging to the first frequency range is lower than the minimum frequency of the frequencies belonging to the second frequency range.

In the case where the transmission resonant coil (L4) 1024 is formed over the second coil PCB 1240, the charging area of the transmission resonant coil (L4) 1024 may be over the second coil PCB 1240. Therefore, the charged areas of the transmission induction coils (L1 to L3) 1015 may at least partially overlap the charging area of the transmission resonant coil (L4) 1024.

According to another embodiment, the positions of the first coil PCB 1220 and the second coil PCB 1240 may be switched.

The second connector 1245 may function to electrically connect the second coil PCB 1240 and the control circuit PCB 1280, and the transmission resonant coils (L4) 1024 and a sensor corresponding to the transmission resonant coils (L4) 1024 may transmit and receive electrical signals to and from the control circuit PCB 1280 via the second connector 1245.

The plastic part 1250 is formed under the second coil PCB 1240 and functions to block the heat generated from the first coil PCB 1220 and the second coil PCB 1240 from being transferred to the control circuit PCB 1280 and to fix the positions of the second coil PCB 1240 and the ferrite part 1260.

The ferrite part 1260 may shield the magnetic field generated by the first coil PCB 1220 and the second coil PCB 1240 to prevent the magnetic field from being transmitted to the control circuit PCB 1280.

The gap 1270 functions to maintain spacing such that the various components mounted on the control circuit PCB 1280 do not contact the ferrite part 1260. Like the gap 1230 disposed between the first coil PCB and the second coil PCB, the gap 1270 may be filled with a non-metallic material, for example, plastics or rubber, in place of the void space. Alternatively, a heat dissipation member for radiating heat may be disposed in the gap. Alternatively, the ferrite part 1260 and the control circuit PCB 1280 may directly contact each other without the gap.

The control circuit PCB 1280 may include elements of the wireless power transmitter 1000 shown in FIG. 10 except the transmission induction coils (L1 to L3) 1015 and the transmission resonant coils (L4) 1024, namely, may include a circuit (which will be referred to as a control circuit) for controlling wireless power output to the coils.

For the wireless power transmitter 1100 shown in FIG. 11, the induction coil 1110 and the resonant coil 1120 are implemented in the same plane, and thus a dead zone, which is a region where charging cannot be performed in a boundary region between the induction coil 1110 and the resonant coil 1120, may be formed.

For the wireless power transmitter 1200 according to an embodiment of the present disclosure shown in FIG. 12, however, the first coil PCB 1220 including the induction coil and the second coil PCB 1240 including the resonant coil are not implemented in the same plane but are arranged to vertically overlap each other. Therefore, the dead zone, which is a region where charging cannot be performed, may not be formed.

In addition, the first coil PCB 1220 including the induction coil is arranged close to the upper case 1210 where the wireless power receiver is positioned, such that the induction coil, the wireless power transmission efficiency of which is greatly affected by the distance from the wireless power receiver, is positioned closer to the wireless power receiver. The second coil PCB 140 including the resonant coil, the wireless power transmission efficiency of which is not greatly affected by the distance from the wireless power receiver, is positioned under the first coil PCB. Thereby, wireless power transmission efficiency may be optimized.

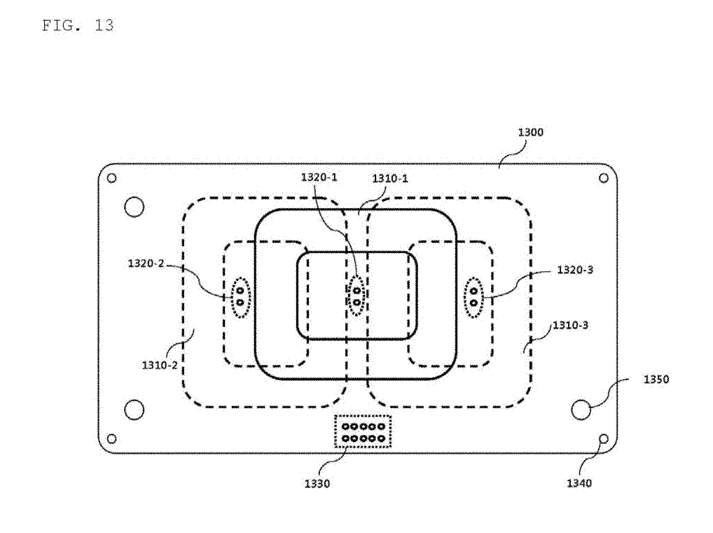

FIG. 13 is a simplified plan view of a first coil PCB shown in FIG. 12.

Referring to FIG. 13, the first coil PCB 1300 corresponds to the first coil PCB 1220 shown in FIG. 12, and may include transmission induction coils 1310-1 to 1310-3, thermistor terminals 1320-1 to 1320-3, first terminals 1330 of the connector 1225, a first coupling hole 1340, and a second coupling hole 1350.

The transmission induction coils 1310-1 to 1310-3 may correspond to the transmission induction coils (L1 to L3) 1015 shown in FIG. 10, respectively. Each of the transmission induction coils 1310-1 to 1310-3 is a coil patterned in a spiral structure. The transmission induction coils 1310-1 to 1310-3 are positioned at least partially overlapping each other. This is intended to prevent a dead zone from being formed wherever the wireless power receiver is positioned. The thermistors described with reference to FIG. 12 may be positioned inside each of the transmission induction coils 1310-1 to 1310-3.

In addition, the transmission induction coils 1310-1 to 1310-3 may be configured to be electrically separated from each other. For example, the transmission induction coil 1310-1 may be formed over the first coil PCB 1300, and the transmission induction coils 1310-2 and 1310-3 may be formed under the first coil PCB 1300.

Additionally, each of the transmission induction coils 1310-1 to 1310-3 may include two terminals (not shown) connected to the switches 1013-1 to 1013-3 shown in FIG. 10. The two terminals may be connected to one of the terminals 1330 of the first connector 1225.

Each of the thermistor terminals 1320-1 to 1320-3 refers to a terminal of a thermistor corresponding to each of the transmission induction coils (L1 to L3) 1015 as described in FIG. 12, and the two terminals (e.g., 1320-1) of each thermistor may include a ground terminal and a signal terminal. The ground terminal may be connected to the ground, and the signal terminal may be connected to one of the terminals 1330 of the first connector 1225.

The terminals 1330 of the first connector 1225 may be connected to the transmission induction coils 1310-1 to 1310-3 and the thermistor terminals 1320-1 to 1320-3 as described above, and may be connected to a corresponding terminal of the control circuit PCB 1280 through the first connector of FIG. 12 1225. In particular, the thermistor terminals 1320-1 to 1320-3 may be connected to the controller 1030 of FIG. 10.

The first coupling hole 1340 may be formed at a predetermined position and a coupling mechanism (e.g., a bolt and a nut) for mechanical coupling with the control circuit PCB 1280 may be inserted thereinto.

The second coupling hole 1350 may be formed at a predetermined position and a coupling mechanism (e.g., a bolt and a nut) for mechanical coupling with the second coil PCB 1240 may be inserted thereinto.

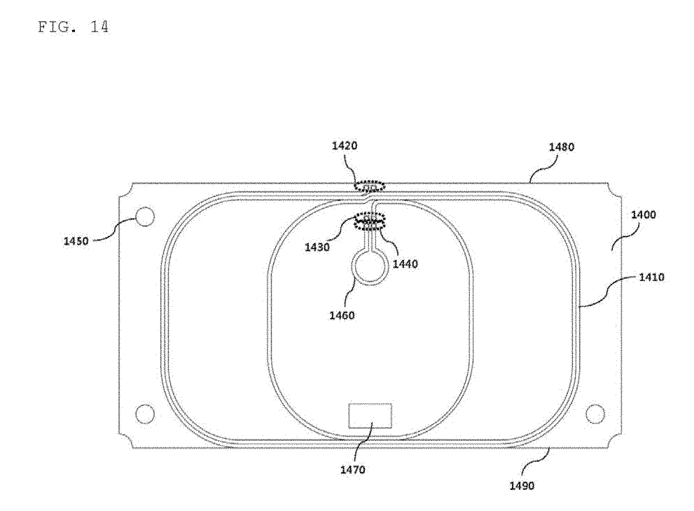

FIG. 14 is a schematic plan view of a second coil PCB shown in FIG. 12.

Referring to FIG. 14, the second coil PCB 1400 corresponds to the second coil PCB 1240 shown in FIG. 12, and may include a transmission resonant coil 1410, terminals 1420, 1430 and 1440 of the second connector 1245, a coupling hole 1450, a sensor 1460, and a connector hole 1470.

The transmission resonant coil 1410 corresponds to the transmission resonant coil (L4) 1024 shown in FIG. 10 and may be connected to the terminals 1420 and 1430 of the second connector 1245 so as to be connected to the matching circuit 1022 shown in FIG. 10.

The terminals 1420, 1430 and 1440 of the second connector 1245 may be connected to the transmission resonant coil 1410 and the sensor 1460 and may be connected to the corresponding terminals of the control circuit PCB 1280 via the second connector 1245 of FIG. 12. In particular, the sensor 1460 may be connected to the controller 1030 of FIG. 10.

The coupling hole 1450 may be formed at a predetermined position, and a coupling mechanism (e.g., a bolt and a nut) for mechanical coupling with the first coil PCB 1220 may be inserted thereinto.

The sensor 1460 may sense the intensity of the magnetic field generated in the transmission resonant coil 1410 and convert the intensity into an electrical signal to be output, as described in FIG. 12.

The connector hole 1470 may be formed at a predetermined position to provide a space allowing the first connector 1225 to pass therethrough. The predetermined position may be set to a position where the connector hole is spaced apart from the terminals 1420, 1430 and 1440 of the second connector 1245 as far as possible and the first connector 1225 is easily connected to the control circuit PCB 1280. In addition, the predetermined position may be disposed outside the transmission induction coils 1310-1 to 1310-3 in consideration of the positions of the transmission induction coils 1310-1 to 1310-3 so as not to vertically overlap the transmission induction coils 1310-1 to 1310-3.

In an embodiment of the present disclosure, the connector hole 1470 may be disposed at a position on the second coil PCB 1400 corresponding to the outside of the transmission induction coils 1310-1 to 1310-3. Since the outer diameter of the transmission resonant coil 1410 is larger than the outer diameters of the transmission induction coils 1310-1 to 1310-3, the connector hole 1470 may be disposed inside the transmission resonant coil 1410, rather than outside the transmission resonant coil 1410 in order to miniaturize the module.

Here, the connector hole 1470 may be disposed at a position opposite to the position where the terminals 1420, 1430 and 1440 of the second connector 1245 are disposed in order to reduce interference between the connectors. The opposite position refers to a position which is close to a second outline 1490 facing a first outline line 1480 of the second coil PCB 1400 close to the terminals 1420, 1430 and 1440 of the second connector 1245. In FIG. 14, the first outline 1480 refers to the horizontal edge of the second coil PCB 1400 positioned on the upper side of the terminals 1420, 1430 and 1440 of the second connector 1245, and the second outline 1490 refers to the horizontal edge of the second coil PCB 1400 positioned on the lower side of the connector hole 1470.

The predetermined position mentioned in FIG. 13 and refers to a position determined in consideration of the sizes, implementation forms and positions of the transmission induction coils 1310-1 to 1310-3 and the transmission resonant coil 1410. The position may be changed depending on the design purpose (for example, maximization of the degree of integration of the respective devices), and is not limited to the positions shown in FIGS. 13 and 14.

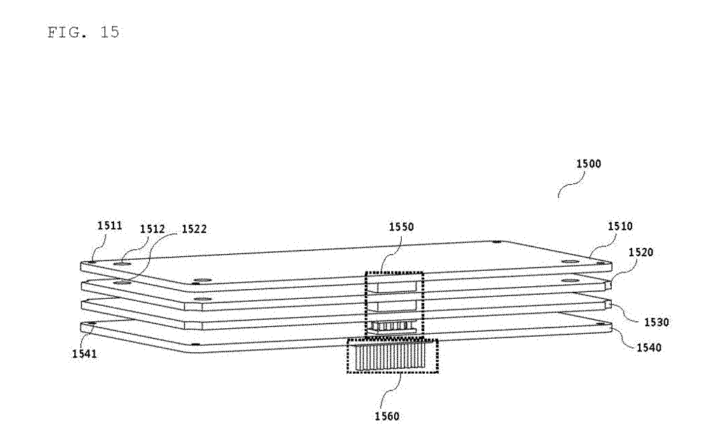

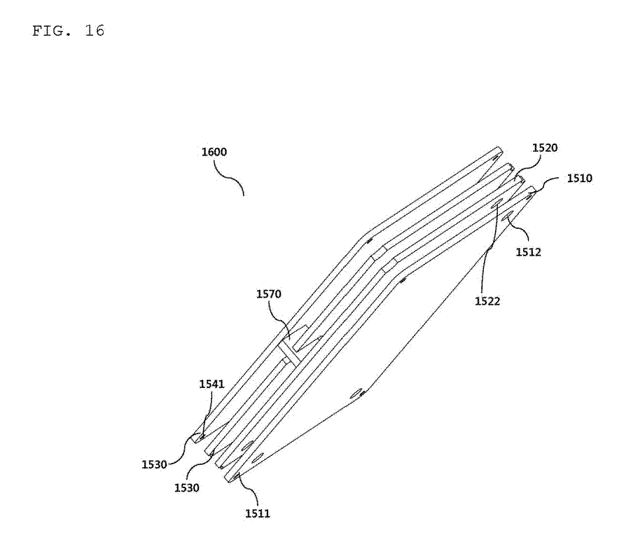

FIG. 15 is a view showing one side of coupling of the substrates of an embodiment shown in FIG. 12. FIG. 16 is a view showing another side of an embodiment of coupling of the substrates shown in FIG. 12.

Referring to FIG. 15, on one side of coupling of the substrates of an embodiment, a first coil PCB 1510, a second coil PCB 1520, a ferrite part 1530, a control circuit PCB 1540, and a first connector 1550 are provided.

The first coil PCB 1510, the second coil PCB 1520, the ferrite part 1530, the control circuit PCB 1540 and the first connector 1550 respectively correspond to the first coil PCB 1220, the second coil PCB 1240, the ferrite part 1260, the control circuit PCB 1280, and the first connector 1225 shown in FIG. 12.

The first coil PCB 1510 and the control circuit PCB 1540 may be coupled to each other through the coupling holes 1511 and 1541 at positions corresponding to each other as discussed in FIG. 13.

Similarly, the first coil PCB 1510 and the second coil PCB 1520 may be coupled to each other through the coupling holes 1512 and 1522 at positions corresponding to each other discussed in FIG. 13.

The first coil PCB 1510 and the control circuit PCB 1540 may be electrically connected to each other through the first connector 1550. The first connector 1550 may pass through the connector holes at positions corresponding to each other in the second coil PCB 1240 and the ferrite part 1260.

In addition, the control circuit PCB 1540 may be coupled to another substrate (e.g., a power board that supplies power 1050) not shown in FIG. 12 through a plurality of pins 1560.

Referring to FIG. 16, on the other side of coupling of the substrates of the embodiment shown in FIG. 12, the first coil PCB 1510, the second coil PCB 1520, the ferrite part 1530, the control circuit PCB 1540, and a second connector 1570 are provided. The other side 1600 corresponds to the side viewed from the opposite side to that of FIG. 15.

The second coil PCB 1520 and the control circuit PCB 1540 may be electrically connected through the second connector 1570. The second connector 1520 may pass through the connector hole at the corresponding position in the ferrite part 1260.

The method according to embodiments of the present disclosure described may be implemented as a program to be executed on a computer and stored in a computer-readable recording medium. Examples of the computer-readable recording medium include ROM, RAM, CD-ROM, magnetic tapes, floppy disks, and optical data storage devices, and also include carrier-wave type implementation (e.g., transmission over the Internet).

The computer-readable recording medium may be distributed to a computer system connected over a network, and computer-readable code may be stored and executed thereon in a distributed manner. Functional programs, code, and code segments for implementing the method described above may be easily inferred by programmers in the art to which the embodiments pertain.

It is apparent to those skilled in the art that the present disclosure may be embodied in specific forms other than those set forth herein without departing from the spirit and essential characteristics of the present disclosure.

Therefore, the above embodiments should be construed in all aspects as illustrative and not restrictive. The scope of the disclosure should be determined by the appended claims and their legal equivalents, and all changes coming within the meaning and equivalency range of the appended claims are intended to be embraced therein.

### INDUSTRIAL APPLICABILITY

The present disclosure relates to a wireless transmission technique and is applicable to a wireless power transmitter on which a plurality of transmission coils is mounted.

1. A wireless power transmitter supporting multiple modes, comprising:
a first coil PCB (printed circuit board) comprising an induction coil for transmitting a power signal of a first frequency band to a wireless power receiver coil having a first coupling coefficient;
a second coil PCB formed over or under the first coil PCB, the second coil PCB comprising a resonant coil for transmitting a power signal of a second frequency band to a wireless power receiver coil having a second coupling coefficient; and
a control circuit PCB formed under the first coil PCB and the second coil PCB and configured to control the induction coil and the resonant coil,
wherein a charging area of the induction coil is over the first coil PCB, and a charging area of the resonant coil is over the second coil PCB,
wherein the charging area of the induction coil at least partially overlaps the charging area of the resonant coil.

2. The wireless power transmitter according to claim 1, further comprising:
a first connector configured to electrically connect the first coil PCB and the control circuit PCB.

3. The wireless power transmitter according to claim 2, wherein the second coil PCB comprises a connector hole allowing the first connector to pass therethrough.

4. The wireless power transmitter according to claim 1, further comprising:
a second connector configured to electrically connect the second coil PCB and the control circuit PCB.

5. The wireless power transmitter according to claim 1, wherein the induction coil comprises three transmission induction coils positioned to at least partially overlap each other.

6. The wireless power transmitter according to claim 1, further comprising:
ferrite for shielding a magnetic field, the ferrite being positioned between the second coil PCB and the control circuit PCB.

7. The wireless power transmitter according to claim 1, wherein the first coupling coefficient is greater than the second coupling coefficient,
wherein a range of the first frequency band is below a range of the second frequency band.

8. The wireless power transmitter according to claim 1, wherein a range of the first coupling coefficient is from 0 to 0.2 and a range of the first frequency band is from 90 kHz to 300 kHz or from 100 kHz to 220 kHz.

9. The wireless power transmitter according to claim 1, wherein a range of the second coupling coefficient is from 0.5 to 1.0 and a range of the second frequency band is from 6 MHz to 8 MHz.

10. A wireless power transmitter supporting multiple modes, comprising:
a first coil PCB (printed circuit board) comprising an induction coil for transmitting a power signal of a first frequency band to a wireless power receiver coil having a first coupling coefficient;
a second coil PCB formed over or under the first coil PCB, the second coil PCB comprising a resonant coil for transmitting a power signal of a second frequency band to a wireless power receiver coil having a second coupling coefficient;
a control circuit PCB formed under the first coil PCB and the second coil PCB and configured to control the induction coil and the resonant coil; and
a first connector configured to electrically connect the first coil PCB and the control circuit PCB,
wherein a charging area of the induction coil is over the first coil PCB, and a charging area of the resonant coil is over the second coil PCB,
wherein the charging area of the induction coil at least partially overlaps the charging area of the resonant coil.

11. The wireless power transmitter according to claim 10, further comprising:
a second connector configured to electrically connect the second coil PCB and the control circuit PCB.

12. The wireless power transmitter according to claim 11, wherein the first connector and the second connector are positioned on opposite sides.

13. The wireless power transmitter according to claim 10, wherein the second coil PCB comprises a connector hole allowing the first connector to pass therethrough.

14. The wireless power transmitter according to claim 10, wherein the first coupling coefficient is greater than the second coupling coefficient,
wherein a range of the first frequency band is below a range of the second frequency band.

15. The wireless power transmitter according to claim 10, wherein a range of the first coupling coefficient is from 0 to 0.2 and a range of the first frequency band is from 90 kHz to 300 kHz or from 100 kHz to 220 kHz.

16. The wireless power transmitter according to claim 10, wherein a range of the second coupling coefficient is from 0.5 to 1.0 and a range of the second frequency band is from 6 MHz to 8 MHz.
